(19) United States
(12) Patent Application Publication
(10) Pub. No.: US 2010/0076108 A1
(43) Pub. Date: Mar. 25, 2010

(54) METHOD OF PRODUCING PHTHALOCYANINE PIGMENT NANO-SIZED PARTICLE DISPERSION, AND METHOD OF PRODUCING AN INKJET INK FOR A COLOR FILTER CONTAINING THE DISPERSION; AND COLORED LIGHT-SENSITIVE RESIN COMPOSITION, LIGHT-SENSITIVE TRANSFER MATERIAL, AND COLOR FILTER, CONTAINING THE DISPERSION; AND COLORED LIGHT-SENSITIVE RESIN COMPOSITION, LIGHT-SENSITIVE TRANSFER MATERIAL, AND COLOR FILTER, CONTAINING THE DISPERSION, AND LIQUID CRYSTAL DISPLAY DEVICE AND CCD DEVICE USING THE SAME

(76) Inventors: Yousuke Miyashita, Kanagawa (JP); Hidenori Takahashi, Shizuoka (JP); Keisuke Matsumoto, Shizuoka (JP)

Correspondence Address: BIRCH STEWART KOLASCH & BIRCH, PO BOX 747, FALLS CHURCH, VA, 22040-0747, US

(21) Appl. No.: 12/596,379

(22) PCT Filed: Apr. 16, 2008
(86) PCT No.: PCT/JP2008/057454

§ 371 Date: Oct. 16, 2009

(30) Foreign Application Priority Data
Apr. 17, 2007 (JP) 2007-108047

(51) Int. Cl. C08F 2/46; C08K 5/3415; C09B 67/50

(52) U.S. Cl. 522/75; 524/88; 106/410

(57) ABSTRACT

A method of producing a phthalocyanine pigment nano-sized particle dispersion, containing: mixing a phthalocyanine compound solution of a phthalocyanine compound dissolved in an acid or a good solvent containing an acid, with an organic solvent that is a poor solvent with respect to the phthalocyanine compound, to prepare a mixed liquid in which a phthalocyanine compound crystal is formed, wherein a phthalocyanine compound crystal having one crystalline form selected from the group consisting of α, β, γ, ε, δ, π, ρ, A, B, X, Y, and R is added to the organic poor solvent or the mixed liquid, thereby producing the thus-formed phthalocyanine compound crystal having the same crystalline form as that of the added phthalocyanine compound crystal, and wherein an additive having a mass average molecular weight of 1,000 or more is incorporated therein.

### TECHNICAL FIELD

The present invention relates to a method of producing a phthalocyanine pigment nano-sized particle dispersion, and a method of producing an inkjet ink for a color filter containing the dispersion. Further, the present invention relates relate to a colored light-sensitive resin composition, a light-sensitive transfer material, and a color filter, each of which contains the dispersion; and to a liquid crystal display device using the same.

### BACKGROUND ART

Examples of a factor by which a property of an organic pigment is determined, include crystalline form of thereof. For example, irrespective of a pigment having an identical chemical structure, physical properties, such as hue and fastness of the pigment, significantly vary, owing to a difference in crystalline form. Therefore, each of pigments having a different crystalline form is sometimes separately classified and handled as an independent material. For this reason, for example, also with respect to a pigment composed of a phthalocyanine compound, it has been tried to develop a method of controlling a crystalline form including transformation of a crystalline form to a desired crystalline form, in order to give the pigment properties suitable for the intended use.

For example, it is disclosed that ε-type copper phthalocyanine is formed, by treating α-type copper phthalocyanine at a temperature of 80° C. to 250° C., in the presence of a Lewis acid, such as iodine, in a solvent (see JP-A-2005-272760 (“JP-A” means unexamined published Japanese patent application)). However, in this method, heating and addition of the Lewis acid or the like are necessary. Further, this method is to convert α-type to ε-type, and there is no description of other crystalline forms such as β-type.

Further, there is a proposal to control a crystalline form by changing the condition for re-precipitating a sparingly-soluble organic material dissolved in a supercritical fluid (see Jpn. J. Appl. Phys, 38, L81-L83 (1999)). However, in this method, a large amount of energy is necessary for generation of the supercritical state. Further, this method has a problem with the productivity in an industrial scale.

### DISCLOSURE OF INVENTION

According to the present invention, there is provided the following means:

(1) A method of producing a phthalocyanine pigment nano-sized particle dispersion, comprising:

mixing a phthalocyanine compound solution of a phthalocyanine compound dissolved in an acid or a good solvent containing an acid, with an organic solvent that is a poor solvent with respect to the phthalocyanine compound, to prepare a mixed liquid in which a phthalocyanine compound crystal is formed,

wherein a phthalocyanine compound crystal having one crystalline form selected from the group consisting of α, β, γ, ε, δ, π, ρ, A, B, X, Y, and R is added to the organic poor solvent or the mixed liquid, thereby producing the thus-formed phthalocyanine compound crystal having the same crystalline form as that of the added phthalocyanine compound crystal, and wherein an additive having a mass average molecular weight of 1,000 or more is incorporated therein.

(2) The method of producing a phthalocyanine pigment nano-sized particle dispersion as described in the above, wherein at least one of the additive having a mass average molecular weight of 1,000 or more is a polymer compound represented by formula (1):

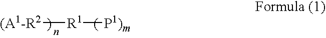

wherein R¹ represents a (m+n)-valent connecting group; R² represents a single bond or a divalent connecting group; A¹ represents a monovalent organic group having a group selected from the group consisting of an acidic group, a nitrogen-containing basic group, a urea group, a urethane group, a group having a coordinating oxygen atom, a hydrocarbon group having 4 or more carbon atoms, an alkoxy silyl group, an epoxy group, an isocyanate group, and a hydroxyl group, or a monovalent organic group containing an organic dye structure or heterocycle each of which may be substituted; when A¹s in the number of n may be the same or different from each other; m represents a number of 1 to 8; n represents a number of 2 to 9; m+n is within the range of 3 to 10; and P¹ represents a group to give a polymer compound.

(3) The method of producing a phthalocyanine pigment nano-sized particle dispersion as claimed in claim (1) or (2), comprising concentrating the mixed liquid, by removing a solvent component in the mixed liquid.
(4) The method of producing a phthalocyanine pigment nano-sized particle dispersion as described in any one of items (1) to (3), comprising, after the concentrating of the mixed liquid, re-dispersing the thus-produced phthalocyanine compound crystal, by adding a redispersion solvent different from each of the good solvent and the organic poor solvent.
(5) A method of producing an inkjet ink for a color filter, in which the dispersion described in any one of items (1) to (4) is obtained as an inkjet ink for a color filter.
(6) A colored photosensitive resin composition, at least comprising:

the dispersion prepared by the method as described in any one of items (1) to (4);

a binder;

a polyfunctional monomer; and

a photopolymerization initiator or a photopolymerization initiator system.

(7) A photosensitive transfer material, at least having a photosensitive resin layer containing the colored photosensitive resin composition as described in item (6), on a temporary support.
(8) A color filter, which is produced with the colored photosensitive resin composition as described in item (6) or the photosensitive transfer material as described in item (7).
(9) A liquid crystal display device, having the color filter as described in item (8).
(10) The liquid crystal display device as described in item (9), which is of a VA-mode.
(11) A CCD device, having the color filter as described in item (8).

Other and further features and advantages of the invention will appear more fully from the following description, taking the accompanying drawings into consideration.

### BRIEF DESCRIPTION OF DRAWINGS

FIG. 1 is a graph showing an absorption spectrum of the below-mentioned dispersion sample 1.

FIG. 2 is a graph showing the result of X-ray diffraction measurement of the below-mentioned crystal sample 1.

FIG. 3 is a graph showing an absorption spectrum of the below-mentioned dispersion sample 2.

FIG. 4 is a graph showing the result of X-ray diffraction measurement of the below-mentioned crystal sample 2.

FIG. 5 is a graph showing an absorption spectrum of the below-mentioned dispersion sample 3.

FIG. 6 is a graph showing the result of X-ray diffraction measurement of the below-mentioned crystal sample 3.

### BEST MODE FOR CARRYING OUT INVENTION

Hereinafter, the present invention will be explained in detail.

In the production method of the present invention, a phthalocyanine compound solution of a phthalocyanine compound dissolved in an acid or a good solvent containing an acid (hereinafter, also referred to as an acid solvent) is mixed with an organic solvent that is a poor solvent to the phthalocyanine compound (hereinafter, also referred to as an organic poor solvent) to give a mixed liquid, so that a phthalocyanine compound crystal is formed in the mixed liquid, which results in a pigment nano-sized particle dispersion. In the production method of the present invention, by the embodiment (i) wherein a phthalocyanine compound crystal having a given crystalline form is contained in an organic poor solvent, or by the embodiment (ii) wherein a phthalocyanine compound crystal having a given crystalline form is added to the mixed liquid, the thus-formed phthalocyanine compound is produced so as to have the same crystalline form as the above-mentioned given crystalline form. In the present invention, the phthalocyanine compound having a given crystalline form that is contained in the organic poor solvent or mixed liquid is also called “a specifically-crystallized phthalocyanine compound”, and sometimes differentiated from “a produced phthalocyanine compound crystal” that is produced by mixing a phthalocyanine solution with an organic poor solvent. On the other hand, collectively they are also called the phthalocyanine compound crystal. Further, in the present invention, the phrase “the thus-produced phthalocyanine compound is produced so as to have the same crystalline form as the given crystalline form” means to exclusively produce crystals having the same crystalline form as the given crystalline form without producing crystals having any other crystalline form.

The given crystalline form is one crystalline form selected from the group consisting of α, β, γ, ε, δ, π, ρ, A, B, X, Y, and R. These types of crystalline forms of the phthalocyanine crystal are described in detail, for example, by Masao Tanaka, “Phthalocyanine—Basic Physical Properties and Application to Functional materials—”, edited by Organic Electronics Kenkyu-kai (JOEM), published by BUNSHIN (1991).

As the phthalocyanine compound that is used in the production method of the present invention, non-metal phthalocyanine and various kinds of metal phthalocyanines may be used. Examples of the metal of the metal phthalocyanine include Cu, Ti, V, Cr, Fe, Co, Ni, Zn, Mg, Na, K, Be, Ca, Ba, Cd, Hg, Pt, Pd, Li, Sn, and Mn. Further, as exemplified by vanadyl phthalocyanine and titanyl phthalocyanine, oxygen or the like may be coordinated to the metal. These metal phthalocyanines may be a halogenated derivative in which a hydrogen atom of the phthalocyanine is substituted with a halogen atom such as a chlorine atom. Further, a substituent such as a sulfo group, or a —SH group may be introduced into the phthalocyanine. The phthalocyanine compound should not be crystallized in a solution of the phthalocyanine compound dissolved in a good solvent.

In the present invention, the good solvent is defined as a good solvent that is able to dissolve a phthalocyanine compound, and it is preferable to dissolve the phthalocyanine compound in an amount of 0.1% by mass or more, more preferably 0.5% by mass or more, and further preferably 1% by mass or more.

The acid or the solvent containing both an acid and another solvent therein is not particularly limited, as long as the acid or solvent is able to dissolve a phthalocyanine compound. However, inorganic acids such as sulfuric acid, and organic acids are preferable. Among these acids and solvents, alkyl sulfonic acids, alkyl carboxylic acids, halogenated alkyl sulfonic acids, halogenated alkyl carboxylic acids, aromatic sulfonic acids, aromatic carboxylic acids, or a mixture of two or more thereof are more preferable. Alkyl sulfonic acids or aromatic sulfonic acids are further preferable. Methane sulfonic acid is especially preferable.

Examples of the solvent that is combined with acid include alcohol compound solvents, amide compound solvents, ketone compound solvents, ether compound solvents, aromatic compound solvents, carbon disulfide solvents, aliphatic compound solvents, nitrile compound solvents, sulfoxide compound solvents, halogen-containing compound solvents, ester compound solvents, ionic liquids, and a mixture thereof. Among these solvents, alcohol compound solvents, amide compound solvents, ketone compound solvents, aromatic compound solvents, and ester compound solvents are preferable. It is preferable that water is not contained in the acid solvent, except for inevitable water.

Examples of the sulfoxide compound solvent include dimethyl sulfoxide, diethyl sulfoxide, hexamethylene sulfoxide, and sulfolane. Examples of the amide compound solvent include N,N-dimethylformamide, 1-methyl-2-pyrrolidone, 2-pyrrolidinone, 1,3-dimethyl-2-imidazolidinone, 2-pyrroridinone, ε-caprolactam, formamide, N-methylformamide, acetamide, N-methylacetamide, N,N-dimethylacetamide, N-methylpropaneamide, and hexamethylphosphoric triamide.

Further, a concentration of the phthalocyanine compound with respect to the acid solvent is preferably in the range of 0.1% by mass to 50% by mass, and more preferably from 1% by mass to 10% by mass.

The preparation condition of the phthalocyanine compound solution is not particularly limited. However, the preparation temperature under ordinary pressure is preferably in the range of 5° C. to 150° C., and more preferably from 20° C. to 80° C. Further, though the preparation is generally conducted under ordinary pressure, it is possible to conduct the preparation under the pressure of, for example, from 100 kPa to 3000 kPa (1 atm to 30 atm).

In the present invention, the poor solvent is defined as a solvent that hardly dissolves a phthalocyanine compound. Solubility with respect to the phthalocyanine compound is preferably 0.01% by mass or less, more preferably 0.005% by mass or less, and further preferably 0.001% by mass or less.

The organic solvent that is used as a poor solvent in the present invention (hereinafter also referred to as an organic poor solvent) is preferably selected from alcohol-series solvents, ketone-series solvents, ether-series solvents, aromatic series solvents, carbon disulfide solvents, aliphatic-series solvents, nitrile-series solvents, sulfoxide-series solvents, halogen-series solvents, ester-series solvents, ionic liquid, and a mixture of two or more kinds of these solvents.

Examples of the alcohol compound solvents include methanol, ethanol, isopropyl alcohol, n-propyl alcohol, 1-methoxy-2-propanol, and the like.

Examples of the ketone compound solvents include acetone, methyl ethyl ketone, methyl isobutyl ketone, cyclohexanone, and the like.

Examples of ether compound solvents include dimethylether, diethylether, tetrahydrofuran, and the like.

Examples of the aliphatic-series solvents include alkylene carbonate.

Examples of the aromatic compound solvents include benzene, toluene, and the like. Examples of the aliphatic compound solvents include hexane, and the like.

Examples of the nitrile compound solvents include acetonitrile, and the like. Examples of the halogen-containing compound solvents include dichloromethane, trichloroethylene, and the like.

Examples of the sulfoxide compound solvent include dimethyl sulfoxide, diethyl sulfoxide, hexamethylene sulfoxide, and sulfolane.

Examples of the ester compound solvents include ethyl acetate, ethyl lactate, 2-(1-methoxy)propyl acetate, and the like.

Examples of the ionic liquids include a salt of 1-butyl-3-methylimidazolium and PF₆⁻, and the like.

It is preferable that the organic poor solvent is a solvent having dielectric constant of 20 or more. Examples of the organic poor solvent include alcohol compounds, alkylene carbonate compounds, nitrile compounds, and sulfoxide compounds. Among these solvents, alkylene carbonate compounds (for example, propylene carbonate, and ethylene carbonate) are more preferable.

In the production method of the present invention, a specifically-crystallized phthalocyanine compound having one crystalline form selected from the group consisting of α, β, γ, ε, δ, π, ρ, A, B, X, Y, and R is contained in the organic poor solvent or in the mixed liquid that is obtained by mixing the phthalocyanine compound solution with the organic poor solvent, in order to control the crystalline form. It is preferable that this specifically-crystallized phthalocyanine compound is identical to the phthalocyanine compound that is dissolved in the good solvent. When the specifically-crystallized phthalocyanine compound is contained in the organic poor solvent, a content of the phthalocyanine compound is preferably in the range of 0.1% by mass to 50% by mass, and more preferably from 0.5% by mass to 10% by mass.

An average particle size (longer diameter) of the phthalocyanine compound that is contained in the organic poor solvent or the mixed liquid, for control of crystallization, is preferably in the range of 5 nm to 1,000 nm, and more preferably from 10 nm to 100 nm.

When the specifically-crystallized phthalocyanine compound is contained in the organic poor solvent, it is preferable that the phthalocyanine compound is contained in the state of dispersion thereof. As a device for dispersion, for example, an ultrasonic cleaner, an ultrasonic homogenizer, a beads mill, a roll mill or the like may be used.

As a condition for mixing a phthalocyanine compound solution with an organic poor solvent, a mixing pressure is preferably in the range of 10 kPa to 1,000 kPa (0.1 atm to 10 atm), and more preferably from 50 kPa to 500 kPa (0.5 atm to 5 atm). A mixing temperature under ordinary pressure is preferably in the range of 0° C. to 150° C., and more preferably from 25° C. to 85° C.

A mixing ratio by volume (a ratio of (organic acid solvent)/(organic solvent)) of the phthalocyanine compound solution to the organic poor solvent in which a specifically-crystallized phthalocyanine compound is contained is preferably in the range of 1/2 to 1/200, and more preferably from 1/5 to 1/50. Further, in this mixing time, it is preferable that unnecessary water is not contained in a mixed liquid of the phthalocyanine compound solution and the organic poor solvent, except for inevitable water.

A concentration of the phthalocyanine compound crystal, which includes both of the thus-produced phthalocyanine compound crystal and the specifically-crystallized phthalocyanine compound in the mixed liquid (dispersion) after preparation thereof, is not particularly limited. The concentration of the phthalocyanine compound crystal is preferably in the range of 1 g to 50 g, and more preferably from 25 g to 300 g, with respect to 1,000 ml of the mixture respectively.

In the production method of the present invention, it is also possible to produce a phthalocyanine compound crystal having a uniform crystalline form by the above-mentioned embodiment (ii) wherein at first a phthalocyanine compound solution is mixed with an organic poor solvent to prepare a mixed liquid, and then a specifically-crystallized phthalocyanine compound is contained in the resultant mixed liquid.

In this embodiment (ii), a concentration of the phthalocyanine compound that is dissolved in an acid solvent is preferably in the range of 0.5% by mass to 50% by mass, and more preferably from 0.5% by mass to 25% by mass. A mixing ratio of a phthalocyanine compound solution to an organic poor solvent in terms of volume ratio (acid solvent/organic poor solvent ratio) is preferably in the range of 1/1 to 1/500, and more preferably from 1/4 to 1/50 respectively. An addition amount of the specifically-crystallized phthalocyanine compound is preferably in the range of 1 g to 500 g, and more preferably from 10 g to 100 g, with respect to 1,000 ml of the mixed liquid respectively.

Examples of preferable compounds that may be used in combination with the phthalocyanine compound pigment include pigments such as quinacridone compounds, aminoanthraquinone compounds, azo compounds, azo-series metal complex compounds, naththol compounds, polycyclic compounds, isoindolinone compounds, isoindoline compounds, dioxane compounds, thioindigo compounds, anthraquinone compounds, quinophthalone compounds, metal complex compounds, and diketopyrrolopyrrol compounds.

The phthalocyanine pigment nano-sized particle dispersion that is obtained by the production method of the present invention may be easily filtrated, for example, by an ordinary filtration using a filter whereby pigment nano-sized particles may be separated from the dispersion. At that time, it is preferable that the crystalline form of the phthalocyanine pigment nano-sized particles contained in the dispersion is made substantially single form. Herein, the term “dispersion” used in the present invention includes a liquid composition (dispersion liquid), a solid composition, and a semisolid composition paste.

As to an average particle diameter of organic particles, an average scale of a group can be represented by digitalizing by several measurement methods. There are frequently-used parameters, such as mode diameter indicating the maximum value of distribution, median diameter corresponding to the median value in the integral frequency distribution curve, and various average diameters (e.g., number-averaged diameter, length-averaged diameter, area-averaged diameter, weight-averaged diameter, volume-averaged diameter, or the like), and the like. In the present invention, the average particle diameter means a number-averaged diameter, unless otherwise specified. The average diameter of the pigment nano-sized particles (primary particles) is in a nanometer size range.

In the present invention, a ratio (Mv/Mn) of volume-averaged diameter (Mv) to number-averaged diameter (Mn) is used as the indicator of the monodispersity of particles (degree of the uniformity in particle size), unless otherwise particularly specified.

Examples of a method of measuring the particle diameter of the pigment particle include a microscopic method, a gravimetric method, a light scattering method, a light shielding method, an electric resistance method, an acoustic method, and a dynamic light scattering method. Of these, the microscopic method and the dynamic light scattering method are particularly preferable. Examples of a microscope to be used in the microscopic method include a scanning electron microscope and a transmission electron microscope. Examples of a particle measuring device according to the dynamic light scattering method include Nanotrac UPA-EX 150 manufactured by NIKKISO Co., Ltd., and a dynamic light scattering photometer DLS-7000 series manufactured by OTSUKA ELECTRONICS CO., LTD.

In the production method of the present invention, the dispersion may be contained in the phthalocyanine compound solution, or the organic poor solvent. Of these embodiments, it is preferable to contain the dispersion in the organic poor solvent. As a dispersant, polymer dispersants such as polyvinyl pyrrolidone, and low molecular dispersants such as sodium dodecylsulfate may be used. At that time, a concentration of the dispersant is preferably in the range of 0.1% by mass to 50% by mass, and more preferably from 0.5% by mass to 10% by mass.

In more detail, as the dispersing agent, use can be made, for example, of an anionic, cationic, amphoteric, nonionic or pigment-derivative-type, and low-molecular-weight or polymer dispersing agent. The molecular weight of the polymer dispersing agent for use may be any value, as long as the dispersing agent can be uniformly dissolved in a solution, but the polymer dispersing agent preferably has a molecular weight of 1,000 to 2,000,000, more preferably of 5,000 to 1,000,000, still more preferably of 10,000 to 500,000, and particularly preferably of 10,000 to 100,000.

Examples of the polymer dispersing agent include polyvinyl pyrrolidone, polyvinyl alcohol, polyvinyl methyl ether, polyethylene glycol, polypropylene glycol, polyacrylamide, vinyl alcohol/vinyl acetate copolymer, partial-formal products of polyvinyl alcohol, partial-butyral products of polyvinyl alcohol, vinylpyrrolidone/vinyl acetate copolymer, polyethylene oxide/propylene oxide block copolymer, polyacrylic acid salts, polyvinyl sulfuric acid salts, poly(4-vinylpyridine) salts, polyamides, polyallylamine salts, condensed naphthalenesulfonic acid salts, cellulose derivatives, and starch derivatives. Besides, natural polymers can be used, examples of which include alginic acid salts, gelatin, albumin, casein, gum arabic, tragacanth gum, and ligninsulfonic acid salts. Above all, it is preferred to use polyvinyl pyrrolidone. These polymers may be used singly or in combination of two or more. These dispersing agents may be used singly or in combination of two or more thereof. The dispersing agents to be used when dispersing a pigment are described in detail in “Dispersion Stabilization of Pigment and Surface Treatment Technique/Evaluation” (published by Japan Association for International Chemical Information, on December 2001), pp. 29-46.

Examples of the anionic dispersing agent (anionic surfactant) include N-acyl-N-alkyltaurine salts, fatty acid salts, alkylsulfates, alkylbenzenesulfonates, alkylnaphthalenesulfonates, dialkylsulfosuccinates, alkylphosphates, naphthalenesulfonic acid/formalin condensates, and polyoxyethylenealkylsulfates. Among these, N-acyl-N-alkyltaurine salts are particularly preferable. As the N-acyl-N-alkyltaurine salts, those described in JP-A-3-273067 are preferable. These anionic dispersing agents may be used singly or in combination of two or more thereof.

Examples of the cationic dispersing agent (cationic surfactant) include quaternary ammonium salts, alkoxylated polyamines, aliphatic amine polyglycol ethers, aliphatic amines, diamines and polyamines derived from aliphatic amine and aliphatic alcohol; imidazolines derived from aliphatic acid, and salts of these cationic substances. These cationic dispersing agents may be used singly or in combination of two or more thereof.

The amphoteric dispersing agent is a dispersing agent having, in the molecule thereof, an anionic group moiety that an anionic dispersing agent has in the molecule, and a cationic group moiety that an cationic dispersing agent has in the molecule.

Examples of the nonionic dispersing agents (nonionic surfactant) include polyoxyethylenealkyl ethers, polyoxyethylenealkylaryl ethers, polyoxyethylene fatty acid esters, sorbitan fatty acid esters, polyoxyethylenesorbitan fatty acid esters, polyoxyethylenealkylamines, and glycerin fatty acid esters. Among these, polyoxyethylenealkylaryl ethers are preferable. These nonionic dispersing agents may be used singly or in combination of two or more thereof.

The pigment-derivative-type dispersing agent is defined as a dispersing agent that is derived from an organic pigment as a parent material and prepared by chemically modifying a structure of the parent material or that is obtained by a pigment-forming reaction of a chemically-modified pigment precursor. Examples of the pigment-derivative-type dispersing agent include sugar-containing pigment-derivative-type dispersing agents, piperidyl-containing pigment-derivative-type dispersing agents, naphthalene- or perylene-derivative pigment-derivative-type dispersing agents, pigment-derivative-type dispersing agents having a functional group linked through a methylene group to a pigment parent structure, pigment-derivative-type dispersing agents (parent structure) chemically modified with a polymer, pigment-derivative-type dispersing agents having a sulfonic acid group, pigment-derivative-type dispersing agents having a sulfonamido group, pigment-derivative-type dispersing agents having an ether group, and pigment-derivative-type dispersing agents having a carboxylic acid group, carboxylate group, or carboxamido group.

In the producing method of the present invention, it is preferred that a pigment dispersing agent containing an amino group coexists with the organic material. The term “amino group” described herein embraces a primary amino group, a secondary amino group, and a tertiary amino group. The number of amino groups may be one or plural. The pigment dispersing agent containing an amino group may be a pigment derivative compound wherein a substituent having an amino group is introduced to the skeleton of the pigment, or may be a polymer compound polymerized using a monomer having an amino group as a polymerization component. Examples of these compounds include compounds described in JP-A-2000-239554, JP-A-2003-96329, JPA-2001-31885, JP-A-10-339949, and JP-B-5-72943 (“JP-B” means examined Japanese patent publication). However, the present invention is not limited to these compounds.

In the production method of the present invention, it is preferable to remove a solvent component of the mixed liquid containing the phthalocyanine compound crystal thereby concentrating the mixed liquid. Further, it is preferable that the concentrated mixed liquid is subjected to redispersion with a redispersion solvent.

The redispersion solvent (third solvent) is a solvent different from both good solvent (first solvent) and poor solvent (second solvent), each of which is used to produce pigment nano-sized particles. Further, the redispersion solvent is a solvent compatible with each of the first solvent and the second solvent. Specifically, examples thereof include aqueous solvents, alcohol compound solvents, ketone compound solvents, ether compound solvents, aromatic compound solvents, carbon disulfide solvents, aliphatic compound solvents, nitrile compound solvents, halogen-containing compound solvents, ester compound solvents, ionic liquids, and mixed solvents thereof. Among these, aqueous solvents, alcohol compound solvents, ketone compound solvents, ether compound solvents, aliphatic compound solvents, ester compound solvents and mixed solvents thereof are preferable; and aqueous solvents, alcohol compound solvents, ketone compound solvents, ester compound solvents and mixed solvents thereof are more preferable. Specifically, examples of the ester compound solvents include 2-(1-methoxy)propyl acetate, ethyl acetate, and ethyl lactate. Examples of the alcohol compound solvents include methanol, ethanol, n-butanol and isobutanol. Examples of the aromatic compound solvents include benzene, toluene and xylene. Examples of the aliphatic compound solvents include n-hexane and cyclohexane. Examples of the ketone compound solvents include methyl ethyl ketone, acetone, cyclohexanone, and the like. Among these solvents, ethyl lactate, ethyl acetate, acetone, and ethanol are preferable. Especially, ethyl lactate is preferable.

When a mixed solvent is used as the third solvent, the number of solvent and a mixing ratio of the solvents are not particularly limited, and a proper mixed solvent may be selected in accordance with the kind of each of pigments, solvents, and polymer compounds.

The addition amount of the third solvent is not particularly limited, but preferably in the range of 100 parts by mass to 30,000 parts by mass, and more preferably from 500 parts by mass to 10,000 parts by mass with respect to 100 parts by mass of the phthalocyanine compound. When the below-described forth solvent is used, it is preferable that a solvent compatible with a third solvent is selectively used as the third solvent.

A volume of the solvent component to be removed off is not particularly limited. However, in an embodiment of the level at which a solvent component is reduced, it is preferable to remove the solvent in a quantity of 50% by mass or more, and more preferably 75% by mass or more, with respect to a total solvent component. On the other hand, in another embodiment of the level at which a larger amount of the solvent component is removed for powderization, it is preferable to remove the solvent in a quantity of 80% by mass or more, and more preferably 90% by mass or more, with respect to a total solvent component.

A water content of the dispersion from which a solvent component has been removed is not particularly limited. It is preferable to control the water content in the range of 0.01% by mass to 3% by mass, and more preferably from 0.01% by mass to 1% by mass. At that time, it is preferable to remove a solvent component thereby reducing the residue to powder according to a drying method, or the like. For example, it is preferable to control the solid content in the range of 50% by mass to 100% by mass, and more preferably from 70% by mass to 100% by mass.

In the production method of the present invention, a polymer compound having a mass average molecular weight of 1000, or more is contained as an additive in a mixed liquid containing a phthalocyanine compound crystal. The addition step of the polymer compound is not particularly limited, and may be before or after the production of the phthalocyanine compound crystal.

As the addition amount of the polymer compound, there is no particular limitation, as long as the amount is enough to disperse a phthalocyanine pigment in accordance with the quantity of the phthalocyanine compound. However, if the polymer compound is added in excessive quantities, the subsequent dispersion is sometimes suppressed. Therefore, the addition amount of the polymer compound is preferably in the range of 5 parts by mass to 1000 parts by mass, more preferably from 10 parts by mass to 500 parts by mass, and especially preferably from 10 parts by mass to 250 parts by mass with respect to 100 parts by mass of the phthalocyanine compound. When the below-described forth solvent is used, it is preferable that those capable of showing a pigment-dispersive function in the forth solvent are selectively used as the polymer compound to be added.

As the polymer compound having a mass average molecular weight of 1,000 or more, it is preferable to use a polymer compound represented by formula (1).

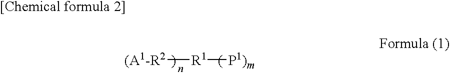

In formula (1), A¹ represents a monovalent organic group having a group selected from the group consisting of an acidic group, a nitrogen-containing basic group, a urea group, a urethane group, a group having a coordinating oxygen atom, a hydrocarbon group having 4 or more carbon atoms, an alkoxy silyl group, an epoxy group, an isocyanate group, and a hydroxyl group, or a monovalent organic group containing an organic dye structure or heterocycle each of which may further be substituted. If n is two or more, plural A¹s may be the same or different.

Specifically, A¹ is not particularly limited. Examples of the “monovalent organic group having an acidic group” include a monovalent organic group having an acid group such as a carboxylic acid group, a sulfonic acid group, a monosulfuric acid ester group, a phosphoric acid group, a monophosphoric acid ester group, and a boric acid. Beside, examples of the “monovalent organic group having a nitrogen-containing basic group” include a monovalent organic group having an amino group (—NH₂), a monovalent organic group having a substituted imino group (—NHR⁸, —NR⁹R¹⁰ (wherein R⁸, R⁹, and R¹⁰ each independently represent an alkyl group having 1 to 20 carbon atoms, an aryl group having 6 to 20 carbon atoms, or an aralkyl group having 7 to 30 carbon atoms), a monovalent organic group having a guanidyl group represented by formula (a1) (wherein, in formula (a1), R^{a1} and R^{a2} each independently represent an alkyl group having 1 to 20 carbon atoms, an aryl group having 6 to 20 carbon atoms, or an aralkyl group having 7 to 30 carbon atoms), and a monovalent organic group having an amidinyl group represented by formula (a2) (wherein, in formula (a2), R^{a3} and R^{a4} each independently represent an alkyl group having 1 to 20 carbon atoms, an aryl group having 6 to 20 carbon atoms, or an aralkyl group having 7 to 30 carbon atoms).

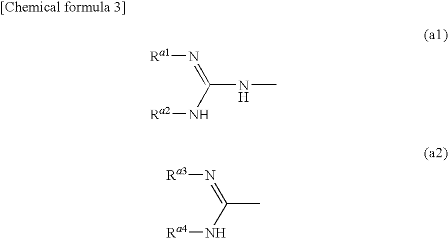

Examples of the “monovalent organic group having a urea group” include —NHCONHR¹⁵ (wherein R¹⁵ represents a hydrogen atom, an alkyl group having 1 to 20 carbon atoms, an aryl group having 6 to 20 carbon atoms, or an aralkyl group having 7 to 30 carbon atoms), and the like.

Examples of the “monovalent organic group having a urethane group” include —NHCOOR¹⁶, —OCONHR¹⁷ (wherein R¹⁶ and R¹⁷ each independently represent an alkyl group having 1 to 20 carbon atoms, an aryl group having 6 to 20 carbon atoms, or an aralkyl group having 7 to 30 carbon atoms), and the like.

Examples of the “monovalent organic group having ‘a group having a coordinating oxygen atom’” include a group having an acetylacetonato group, a group having crown ether, and the like.

Examples of the “monovalent organic group having a hydrocarbon group having 4 or more carbon atoms” include an alkyl group having 4 or more carbon atoms (e.g., an octyl group, a dodecyl group), an aryl group having 6 or more carbon atoms (e.g., a phenyl group, a naphthyl group), an aralkyl group having 7 or more carbon atoms (e.g., a benzyl group), and the like. For the carbon atoms of these groups, there is no specific upper limit; it is, however, preferred that the number of carbon atoms is 30 or less.

Examples of the “monovalent organic group having an alkoxy silyl group” include a group having a trimethoxy silyl group and triethoxy silyl group.

Examples of the “monovalent organic group having an epoxy group” include a group having a glycidyl group.

Examples of the “monovalent organic group having an isocyanate group” include a 3-isocyanatopropyl group.

Examples of the “monovalent organic group having a hydroxyl group” include a 3-hydroxypropyl group.

Among these groups represented by the above-described A¹, preferred are a monovalent organic group having any one of an acidic group, a nitrogen-containing basic group, a urea group, and a hydrocarbon group having 4 or more carbon atoms.

The organic dye structure or heterocycle is not particularly limited. More specifically stated, examples of the organic dye structure include phthalocyanine compounds, insoluble azo compounds, azo lake compounds, anthraquinone compounds, quinacridone compounds, dioxazine compounds, diketopyrrolopyrrole compounds, anthrapyridine compounds, anthanthrone compounds, indanthrone compounds, flavanthrone compounds, perynone compounds, perylene compounds, and thioindigo compounds. Examples of the heterocycle include thiophene, furan, xanthene, pyrrole, pyrroline, pyrrolidine, dioxolan, pyrazole, pyrazoline, pyrazolidine, imidazole, oxazole, thiazole, oxadiazole, triazole, thiadiazole, pyran, pyridine, piperidine, dioxane, morpholine, pyridazine, pyrimidine, piperazine, triazine, trithiane, isoindoline, isoindolinone, benzimidazolone, succinimide, phthalimide, naphthalimide, hydantoin, indole, quinoline, carbazole, acridine, acridone, and anthraquinone.

The organic dye structure or heterocycle may have a substituent T. Examples of the substituent T include an alkyl group having 1 to 20 carbon atoms (e.g., a methyl group, an ethyl group), an aryl group having 6 to 16 carbon atoms (e.g., a phenyl group, a naphthyl group), an acyloxy group having 1 to 6 carbon atoms (e.g., an acetoxy group), an alkoxy group having 1 to 6 carbon atoms (e.g., a methoxy group, an ethoxy group), a halogen atom (e.g., chlorine, bromine), an alkoxycarbonyl group having 2 to 7 carbon atoms (e.g., a methoxycarbonyl group, an ethoxycarbonyl group, a cyclohexyloxycarbonyl group), a cyano group, a carbonic acid ester group (e.g., t-butylcarbonate), a hydroxyl group, an amino group, a carboxyl group, a sulfonamido group, and N-sulfonylamido group.

Besides, the above-described A¹ can be represented by formula (4).

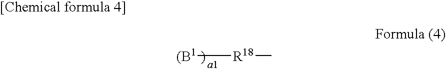

In formula (4), B¹ represents a group selected from the group consisting of an acidic group, a nitrogen-containing basic group, a urea group, a urethane group, a group having a coordinating oxygen atom, a hydrocarbon group having 4 or more carbon atoms, an alkoxy silyl group, an epoxy group, an isocyanate group, and a hydroxyl group, or represents an organic dye structure or heterocycle each of which may further be substituted. R¹⁸ represents a single bond, or (a1)-valent organic or inorganic connecting group. a1 represents 1 to 5. Herein, in the case where a1 is two or more, plural B¹s may be the same or different. Preferable embodiments of the group represented by formula (4) are the same as the A¹.

R¹⁸ represents a single bond, or a (a1+1)-valent connecting group. a1 represents 1 to 5. Examples of the connecting group represented by R¹⁸ include those formed from atoms consisting of from 1 to 100 carbon atoms, from 0 to 10 nitrogen atoms, from 0 to 50 oxygen atoms, from 1 to 200 hydrogen atoms, and from 0 to 20 sulfur atoms, which groups may be unsubstituted or substituted with a substituent. R¹⁸ is preferably an organic connecting group.

Specific examples of R¹⁸ include structural units set forth below, or a group consisted of a combination of said structural units. In addition, the connecting group R¹⁸ may have the aforementioned substituent T.

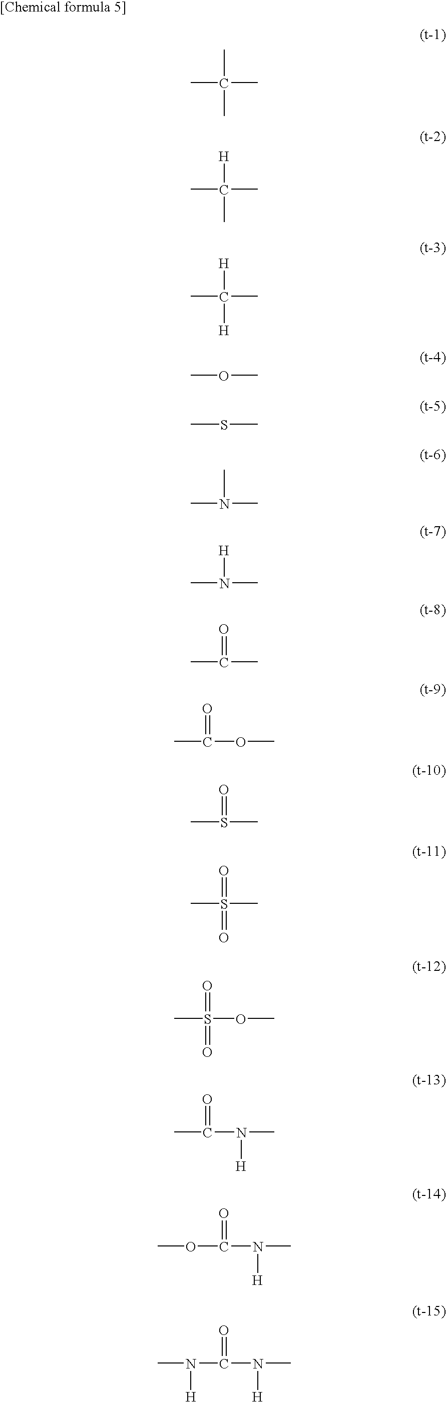

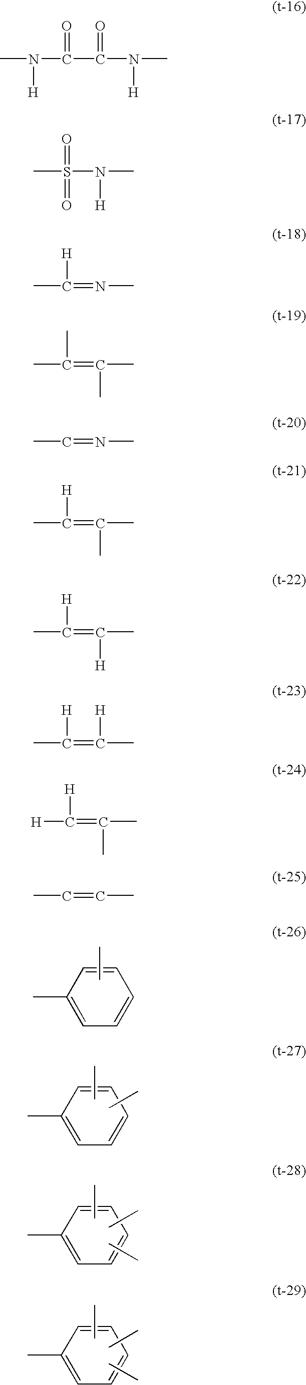

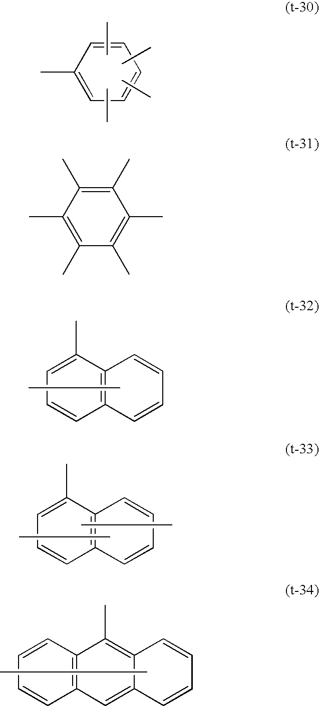

In formula (1), R¹ represents a (m+n)-valent connecting group. m+n is within the range of 3 to 10.

Examples of the (m+n)-valent connecting group represented by R¹ include those groups formed from atoms consisting of from 1 to 100 carbon atoms, from 0 to 10 nitrogen atoms, from 0 to 50 oxygen atoms, from 1 to 200 hydrogen atoms, and from 0 to 20 sulfur atoms, which groups may be unsubstituted or substituted with a substituent. R¹ is preferably an organic connecting group.

Examples of R¹ include the groups of (t-1) to (t-34) or a group (which may have a ring structure) consisted of a combination of a plurality of said groups. In the case where the connecting group R¹ has a substituent, examples of said substituent include the substituent T.

R² represents a single bond or a divalent connecting group. Examples of R² include groups formed from atoms consisting of from 1 to 100 carbon atoms, from 0 to 10 nitrogen atoms, from 0 to 50 oxygen atoms, from 1 to 200 hydrogen atoms, and from 0 to 20 sulfur atoms, which groups may be unsubstituted or substituted with a substituent. Specific examples of R² include the groups of t-3 to t-5, t-7 to t-18, t-22 to t-26, t-32 and t-34, or a group consisted of a combination of a plurality of said groups. It is preferred that R² have a sulfur atom at the position where said R² connect to R¹. In the case where R² has a substituent, examples of said substituent include the substituent T.

In formula (1), m represents 1 to 8. m is preferably 1 to 5, more preferably 1 to 3, and particularly preferably 1 to 2.

n represents 2 to 9. n is preferably 2 to 8, more preferably 2 to 7, and particularly preferably 3 to 6.

In formula (1), P¹ represents a group to give a polymer compound (polymer skeleton). Such the polymer skeleton can be properly selected from ordinary polymers.

In order to form the polymer skeleton, it is preferred to use at least one kind selected from the group consisting of polymers or copolymers derived from a vinyl monomer, ester compound polymers, ether compound polymers, urethane compound polymers, amide compound polymers, epoxy compound polymers, silicone compound polymers, and modified compounds or copolymers of these polymers (e.g. copolymers of polyether/polyurethane, and copolymers of polyether/polymer derived from a vinyl monomer; these copolymers may be any one of a random copolymer, a block copolymer, and a graft copolymer)); more preferred to use at least one kind selected from the group consisting of polymers or copolymers derived from a vinyl monomer, ester compound polymers, ether compound polymers, urethane compound polymers, and modified compounds or copolymers of these polymers; and particularly preferred to use polymers or copolymers derived from a vinyl monomer.

Besides, it is preferred that these polymers are soluble in an organic solvent. If the polymer has a low affinity with the organic solvent, affinity of the polymer with a dispersing medium becomes weak in the case where said polymer is used, for example, as a pigment dispersing agent. Consequently, it becomes sometimes difficult to secure an adsorption layer enough for dispersion stabilization.

It is preferred that P¹ have a sulfur atom at the position where said P¹ connects to R¹.

Of the polymer compounds represented by formula (1), more preferred are those polymer compounds represented by formula (2).

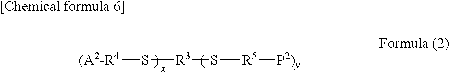

In formula (2), A² has the same meaning as A¹ in formula (1). Specific and preferable embodiments of A² are the same as those of A¹. A² may have a substituent with examples thereof including the substituent T.

In formula (2), R³ represents a (x+y)-valent connecting group. R³ has the same meaning as R¹. The preferable range of R³ is the same as that of R¹. In this case where R³ represents a (x+y)-valent connecting group, the value of said x and its preferable range are the same as those of n in formula (1). Similarly, the value of said y and its preferable range are the same as those of m; the value of said x+y and its preferable range are the same as those of m+n.

The connecting group represented by R³ is preferably an organic connecting group. Preferred specific examples of the organic connecting groups are set forth below. However, the present invention is not limited to these.

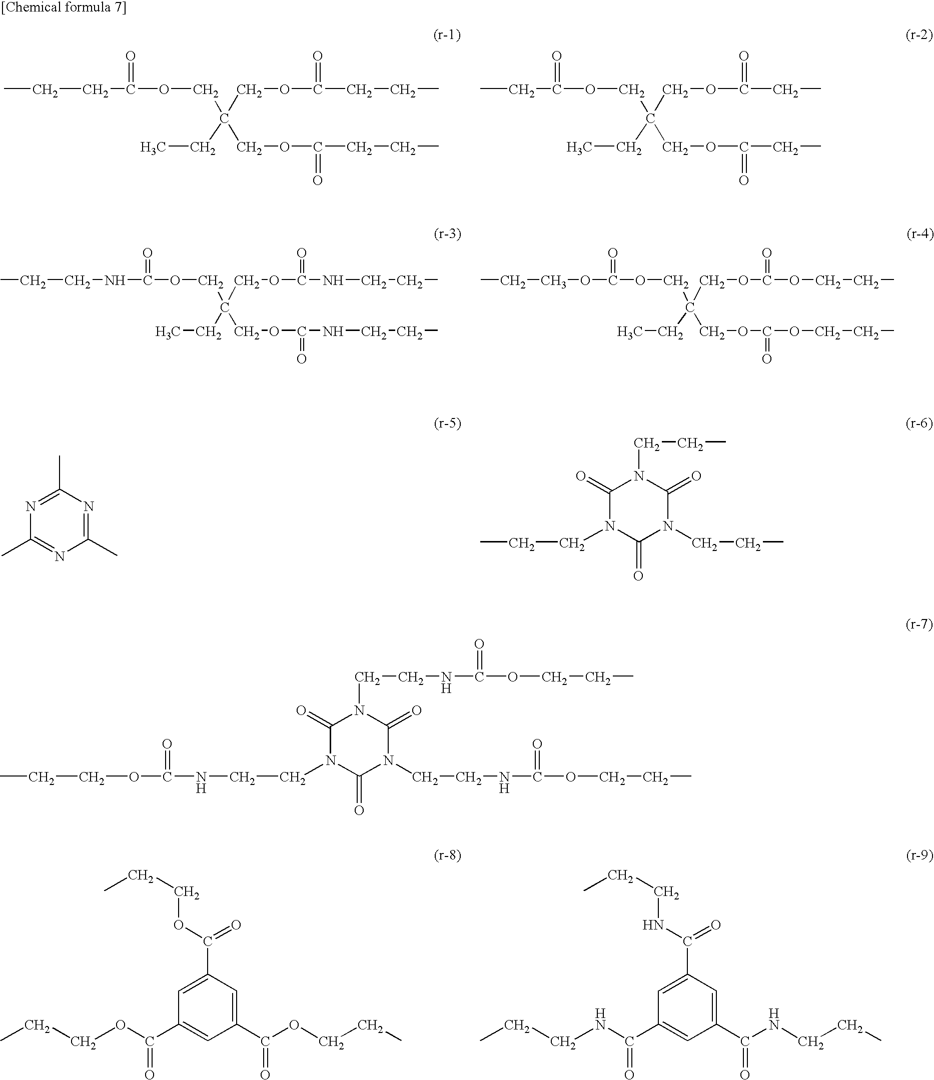

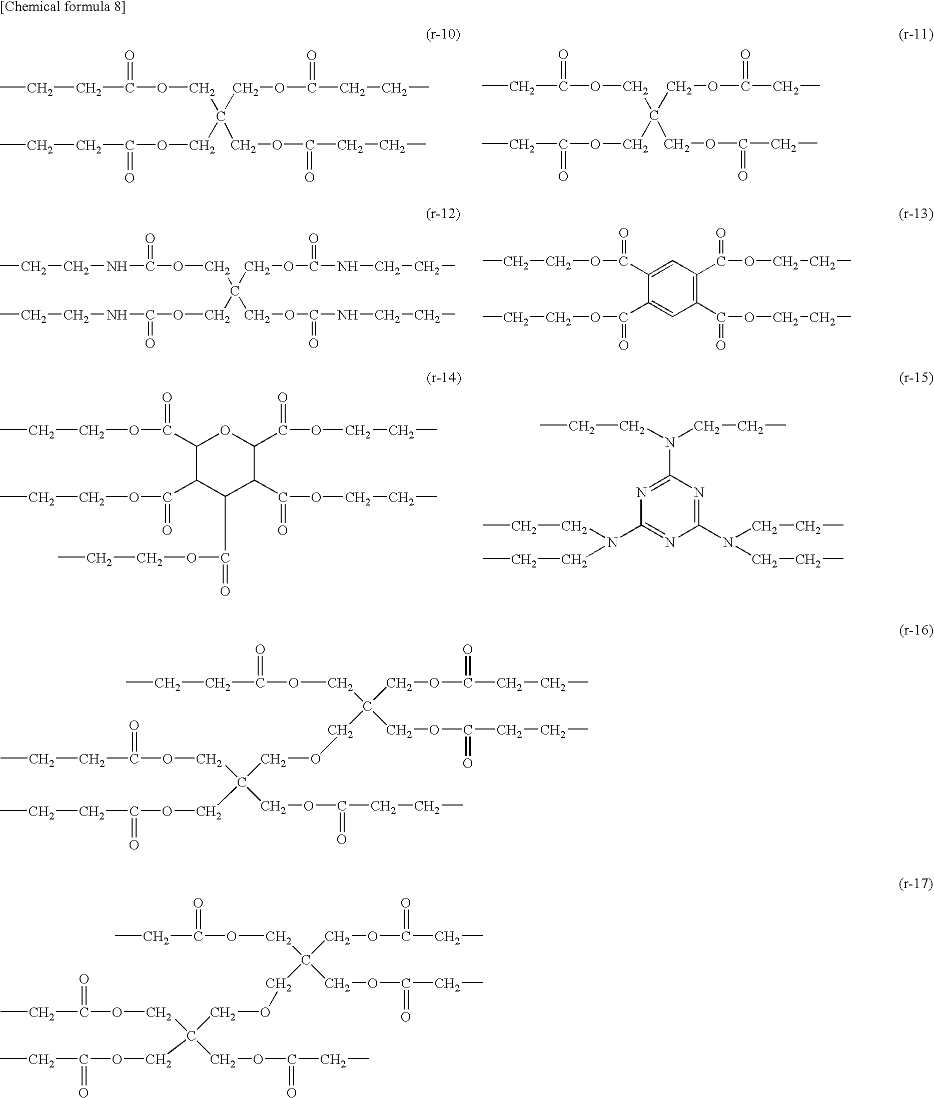

Among the connecting groups, preferred are groups of (r-1), (r-2), (r-10), (r-11), (r-16), and (r-17), from the viewpoints of availability of raw materials, easiness of synthesis, and solubility in various solvents.

In the case where R³ has a substituent, examples of said substituent include the substituent T.

In formula (2), R⁴ and R⁵ each independently represent a single bond or a divalent connecting group.

As the “divalent connecting group” represented by the above-described R⁴ and R⁵, preferred are an optionally substituted, straight chain, branched, or cyclic alkylene, arylene, or aralkylene group, or —O—, —S—, —C(═O)—, —N(R¹⁹)—, —SO—, —SO₂—, —CO₂—, or —N(R²⁰)SO₂—, or a divalent group formed by combining two or more of these groups (wherein R¹⁹ and R²⁰ each independently represent a hydrogen atom or an alkyl group having 1 to 4 carbon atoms). The divalent connecting group is preferably an organic connecting group.

As the R⁴, preferred are a straight chain or branched, alkylene or aralkylene group, or —O—, —C(═O)—, —N(R¹⁹)—, —SO₂—, —CO₂—, or —N(R²⁰)SO₂—, or a divalent group formed by combining two or more of these groups. Especially preferred are a straight chain or branched, alkylene or aralkylene group, or —O—, —C(═O)—, —N(R¹⁹)—, or —CO₂—, or a divalent group formed by combining two or more of these groups.

As the R⁵, preferred are a single bond, a straight chain or branched, alkylene or aralkylene group, or —O—, —C(═O)—, —N(R¹⁹)—, —SO₂—, —CO₂—, or —N(R²⁰)SO₂—, or a divalent group formed by combining two or more of these groups. Especially preferred are a straight chain or branched, alkylene or aralkylene group, or —O—, —C(═O)—, —N(R¹⁹)—, or —CO₂—, or a divalent group formed by combining two or more of these groups.

In the case where R⁴ or R⁵ have a substituent, examples of said substituent include the substituent T.

P² in formula (2) represents a polymer skeleton and can be properly selected from ordinary polymers. Preferred embodiments of the polymers are the same as P¹ in above-described formula (1) and a preferred embodiment thereof is also the same as P¹.

Among the polymer compounds represented by formula (2), especially preferred are polymer compounds in which R³ is the above-described specific group of (r-1), (r-2), (r-10), (r-11), (r-16), or (r-17); R⁴ is a single bond, a straight chain or branched, alkylene or aralkylene group, or —O—, —C(═O)—, —N(R¹⁹)—, or —CO₂—, or a divalent organic group formed by combining two or more of these groups; R⁵ is a single bond, an ethylene group, a propylene group, or a connecting group represented by formula (s-a) or (s-b) set forth below; P² is a homopolymer or copolymer derived from a vinyl monomer, an ester compound polymer, an ether compound polymer, a urethane-series polymer, or a modified compound of these polymers; y is 1 to 2; and x is 3 to 6. In the following groups, R²¹ represents a hydrogen atom or a methyl group, and l represents 1 or 2.

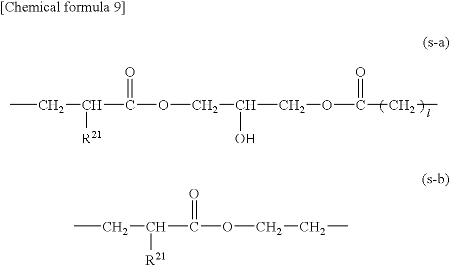

The weight-average molecular weight of the polymer compound used in the producing method of the present invention is at least 1,000, preferably from 3,000 to 100,000, more preferably from 5,000 to 80,000, and especially preferably from 7,000 to 60,000. If the weight-average molecular weight is within the above-described range, a plurality of functional groups introduced to the terminal(s) of the polymer fully exhibit their effects, and thus the polymer compound will exhibit excellent performances in terms of adsorption properties onto a solid surface, micelle-forming property, and surface activating property. Thereby, good dispersibility and dispersion stability can be attained. In the producing method of the present invention, the term “molecular weight” means a mass-average molecular weight, unless otherwise stated. Examples of a method of measuring the molecular weight include a chromatography method, a viscosity method, a light scattering method, and a sedimentation velocity method. In the present specification, a mass-average molecular weight calculated in terms of polystyrene, measured by gel permeation chromatography (carrier: tetrahydrofuran) is used, unless otherwise specifically indicated.

Specific examples of the compound represented by formula (1) that can be preferably used in the producing method of the present invention are shown below. However, the present invention is not limited to these specific examples.

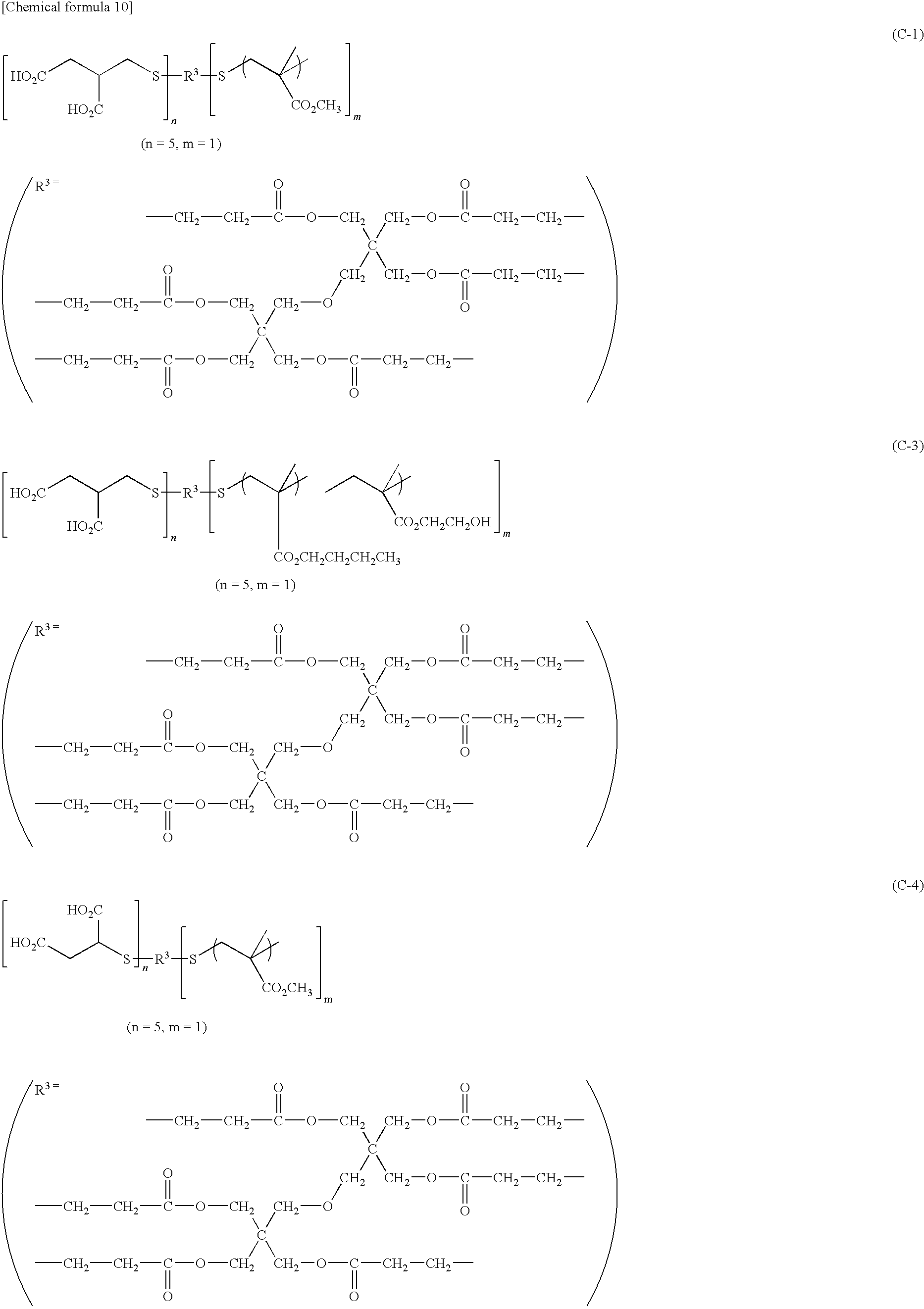

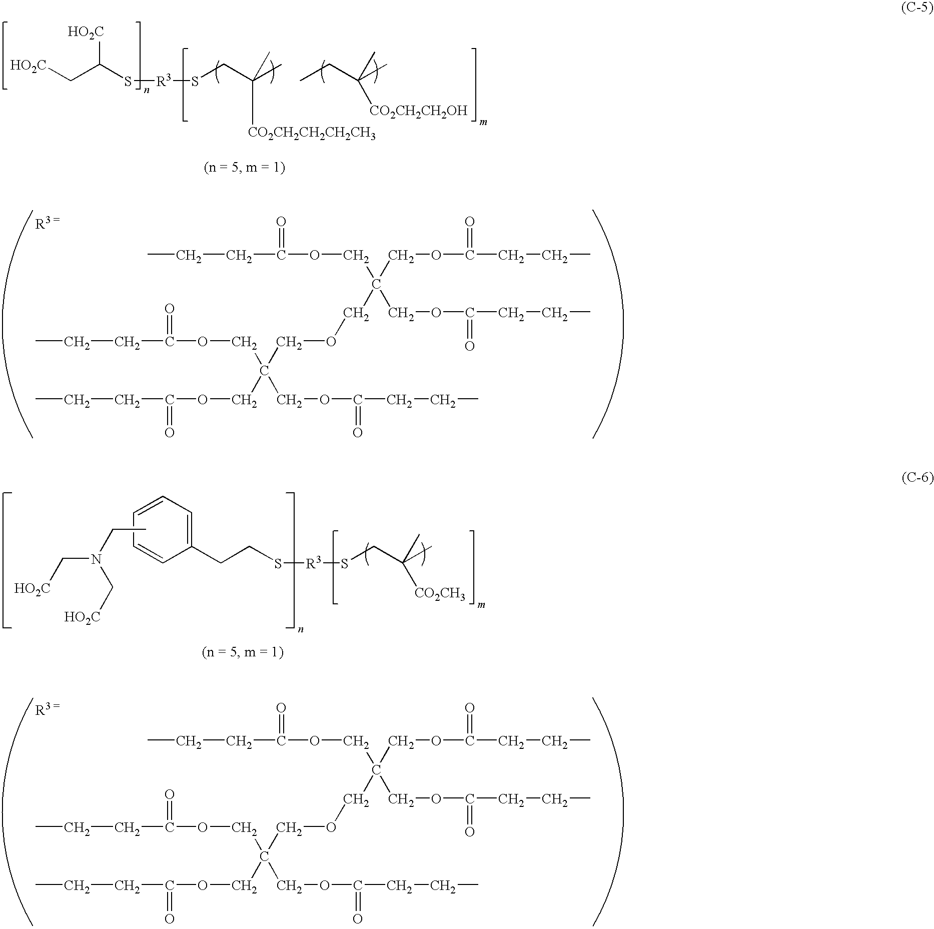

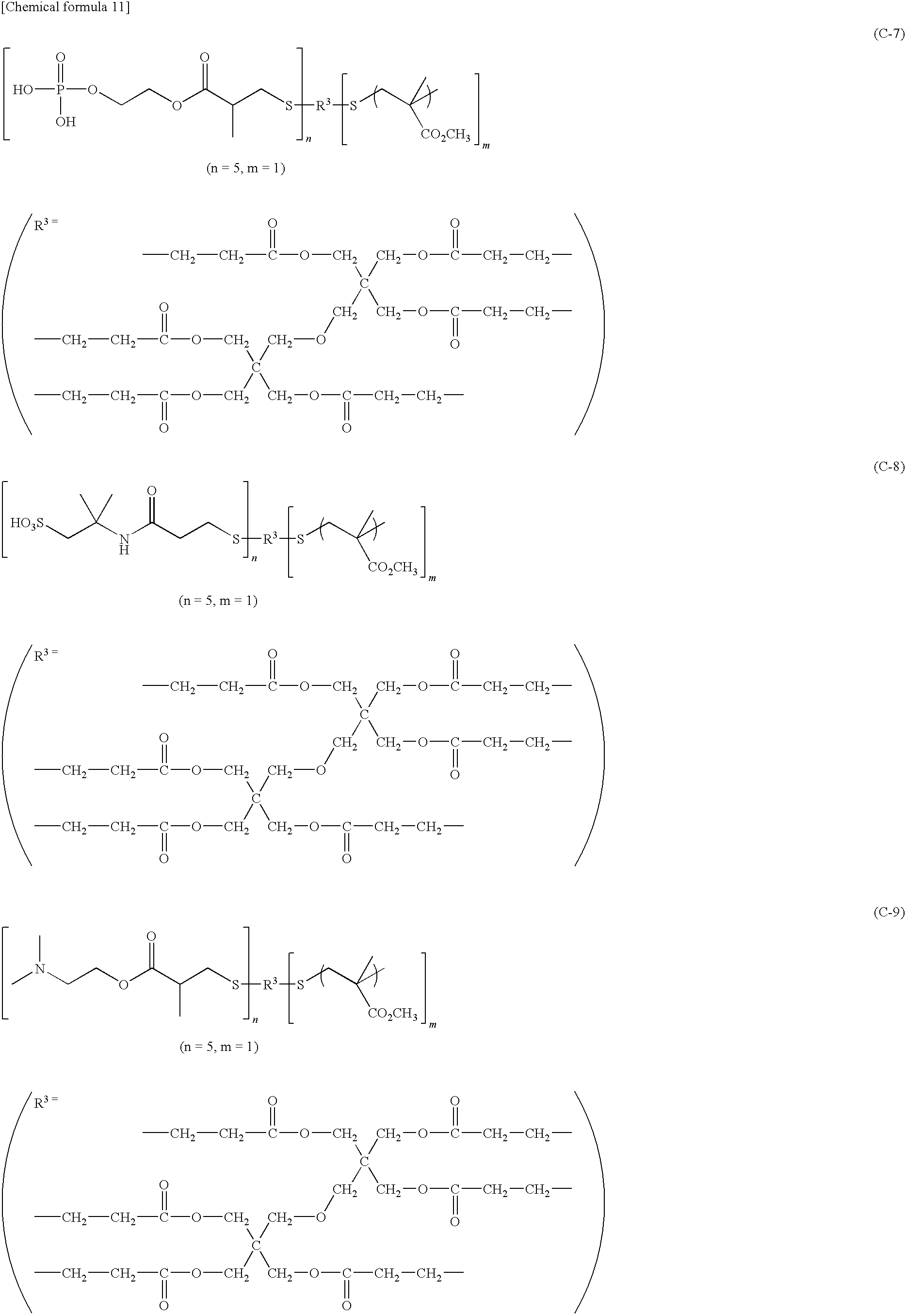

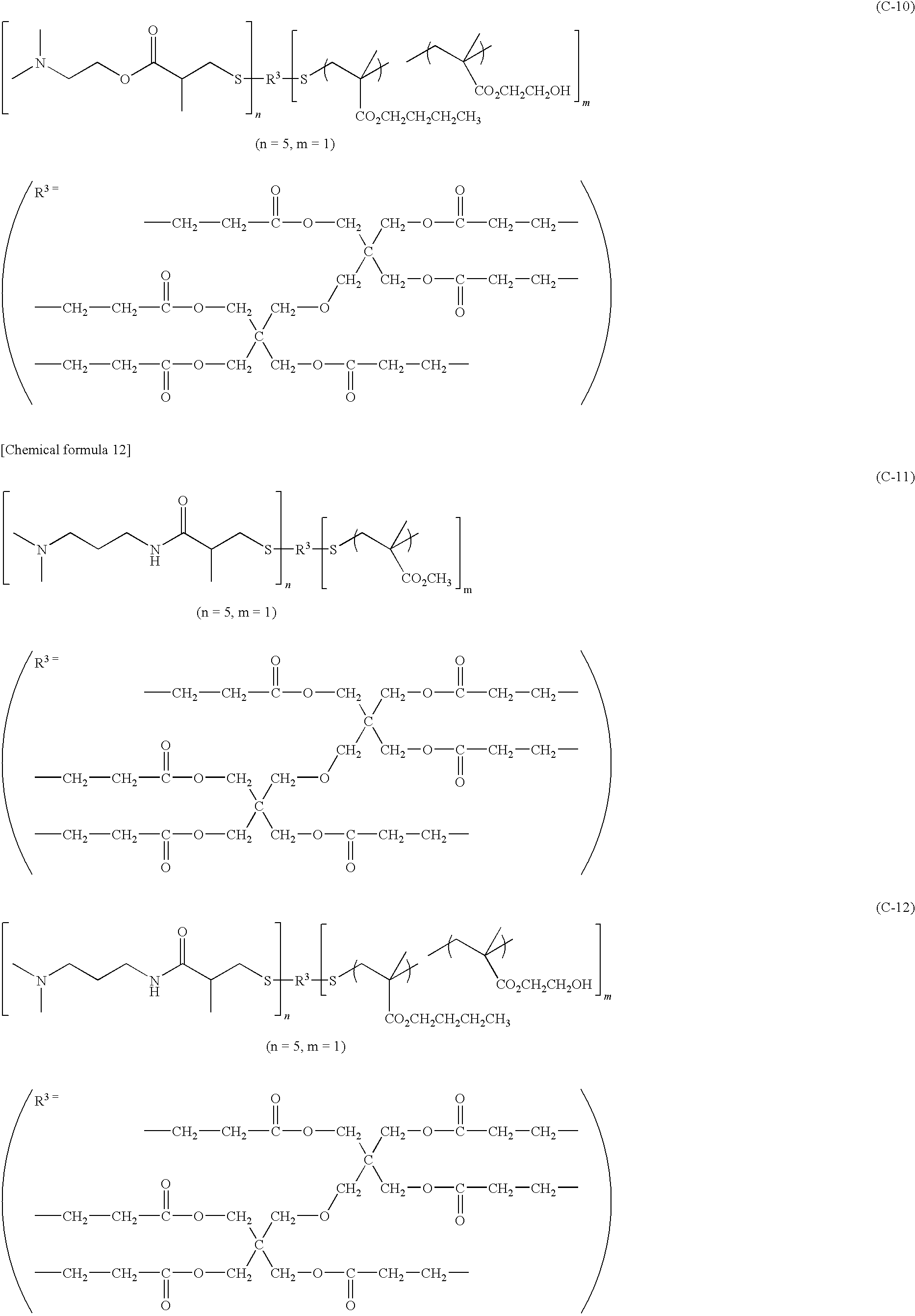

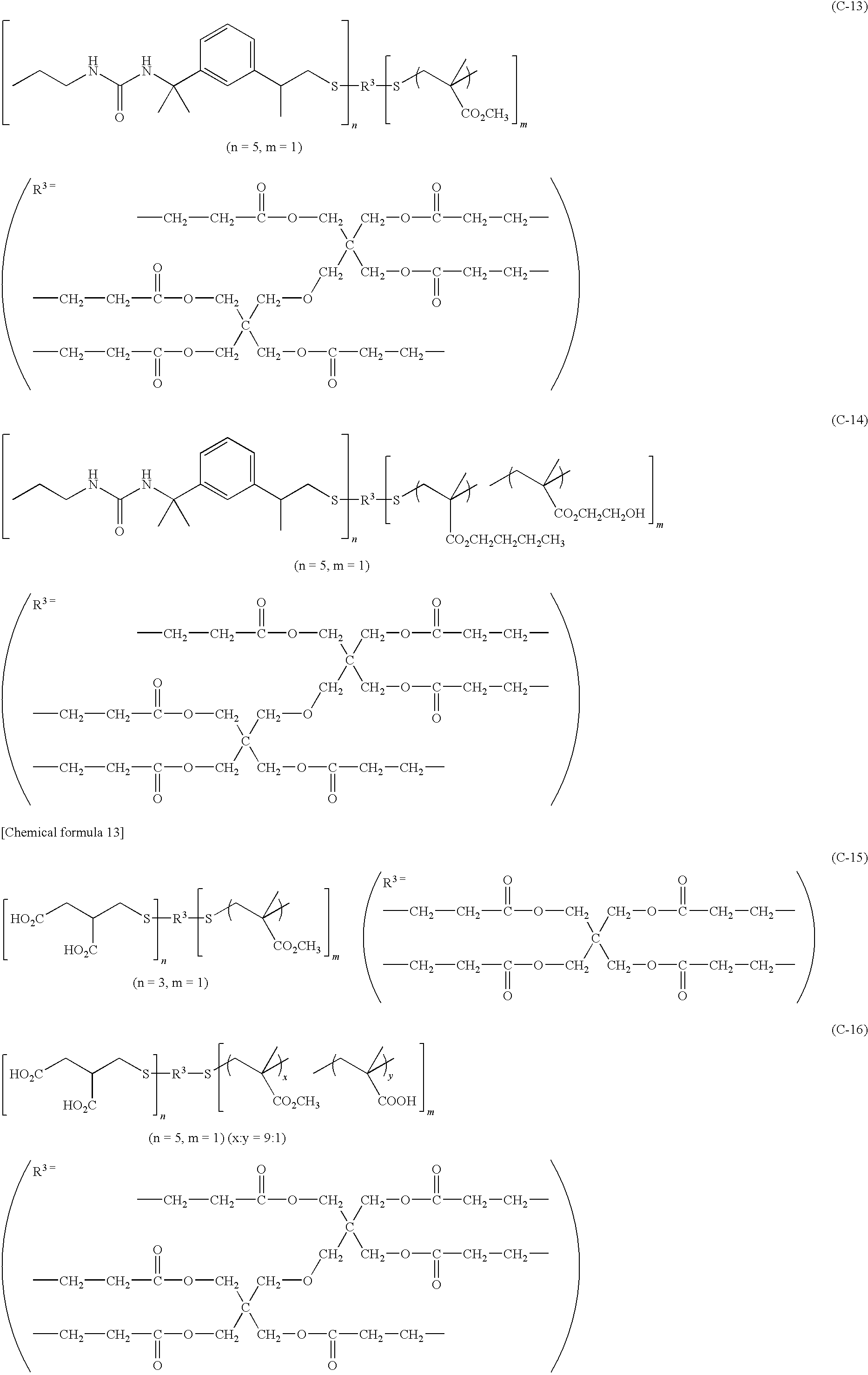

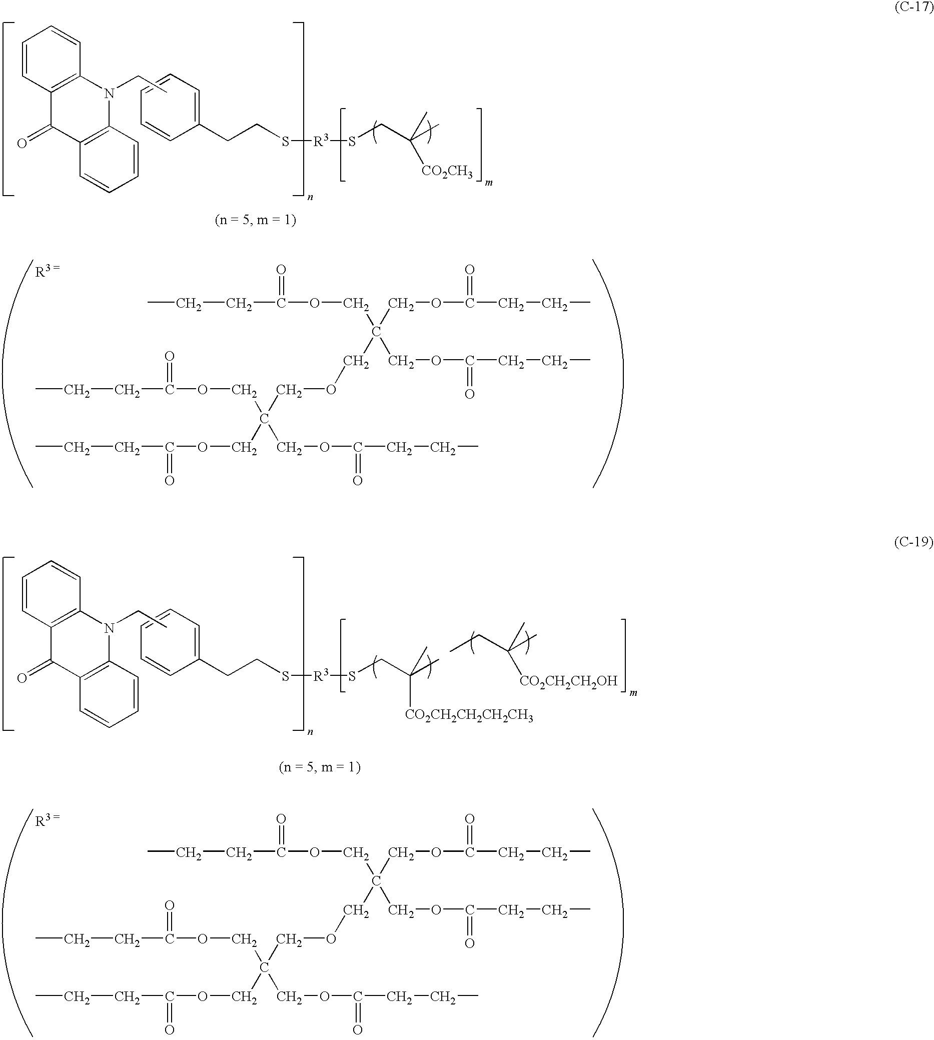

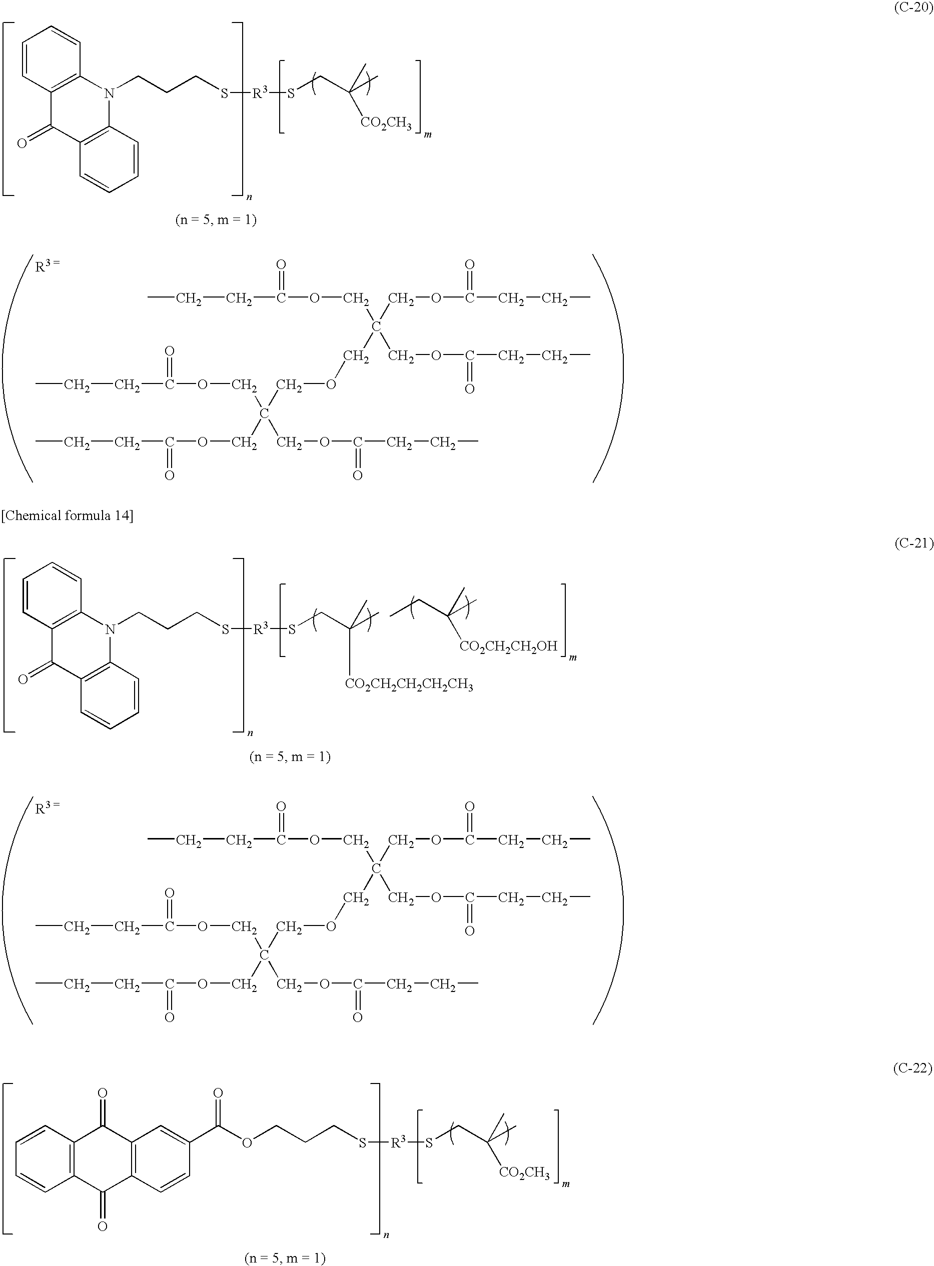

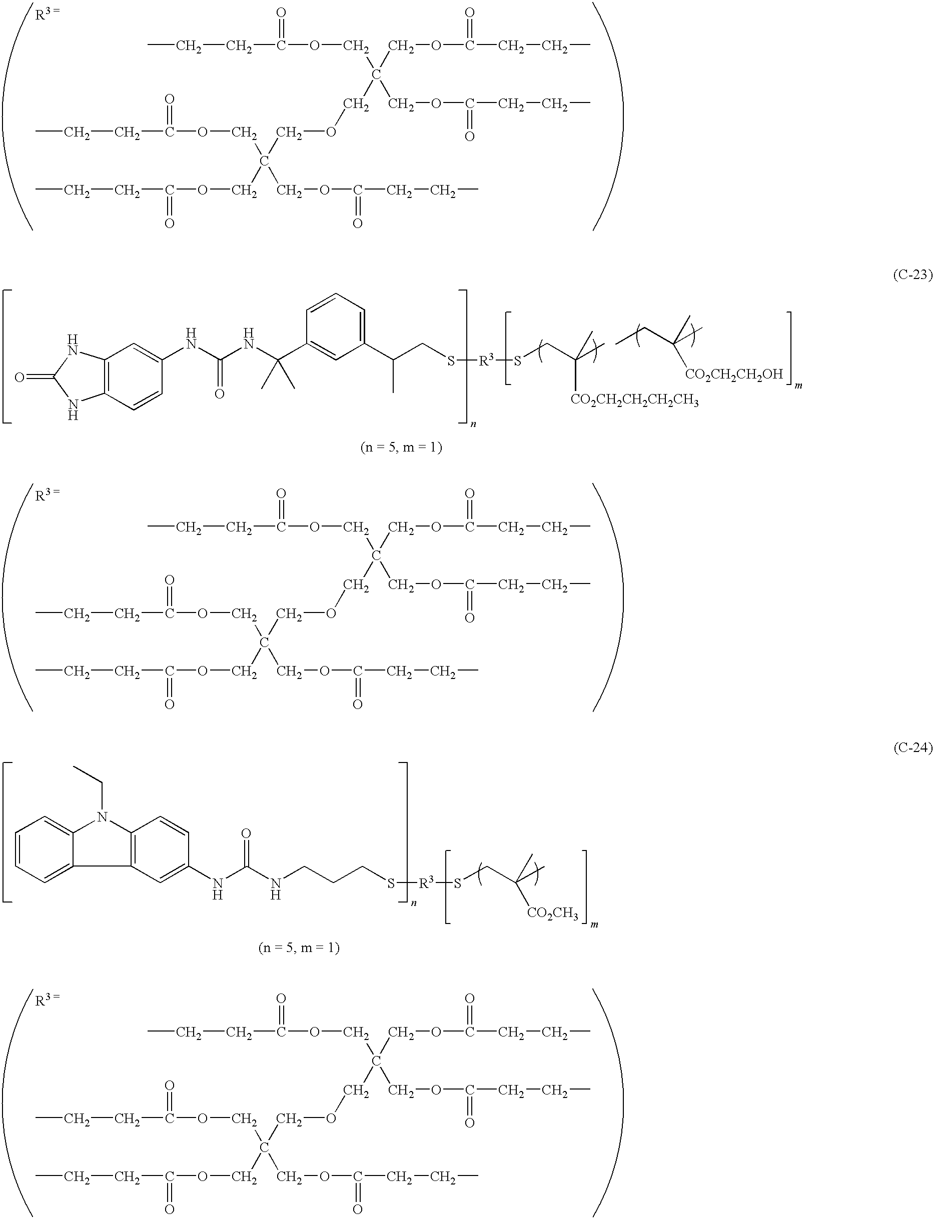

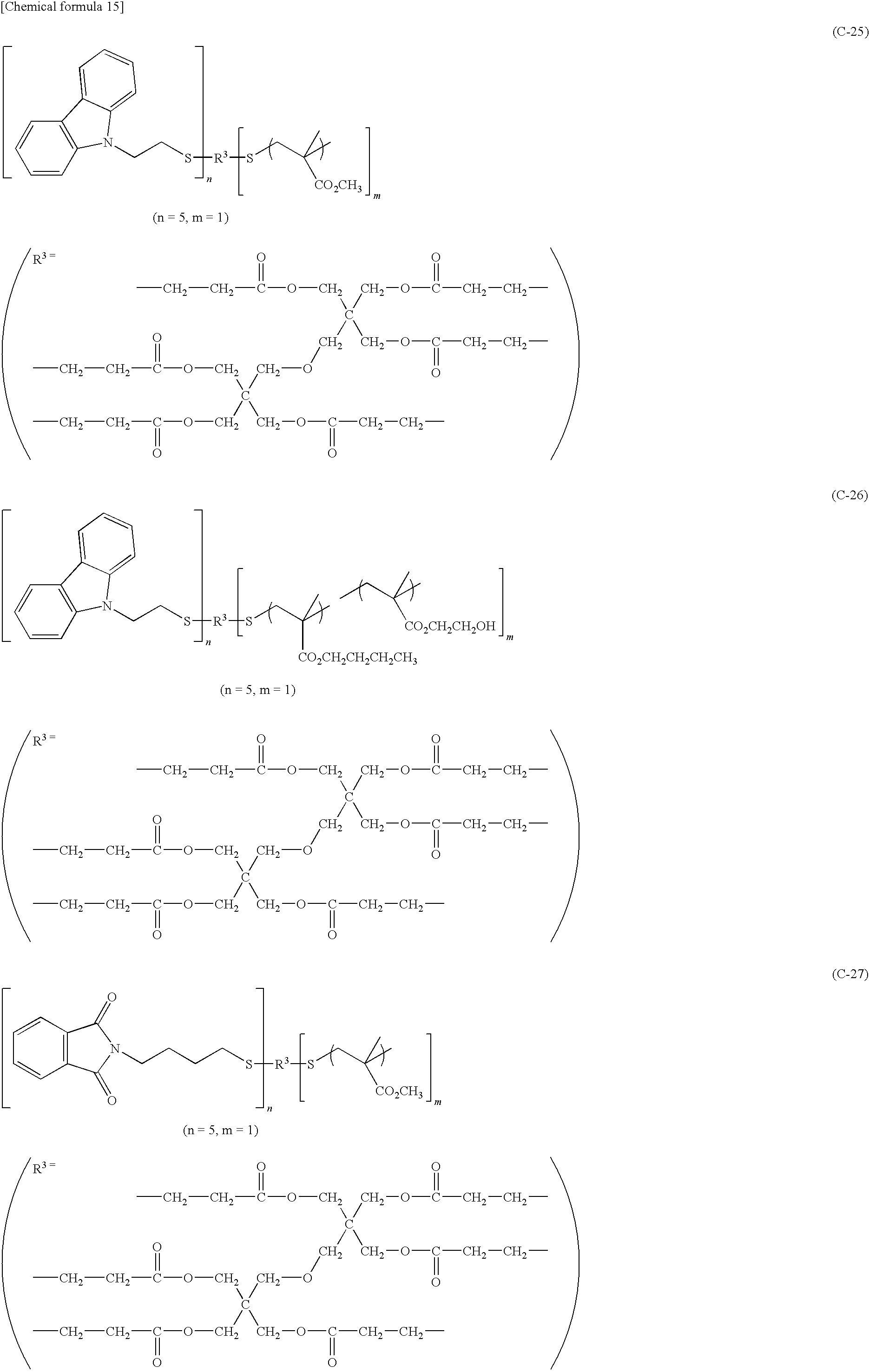

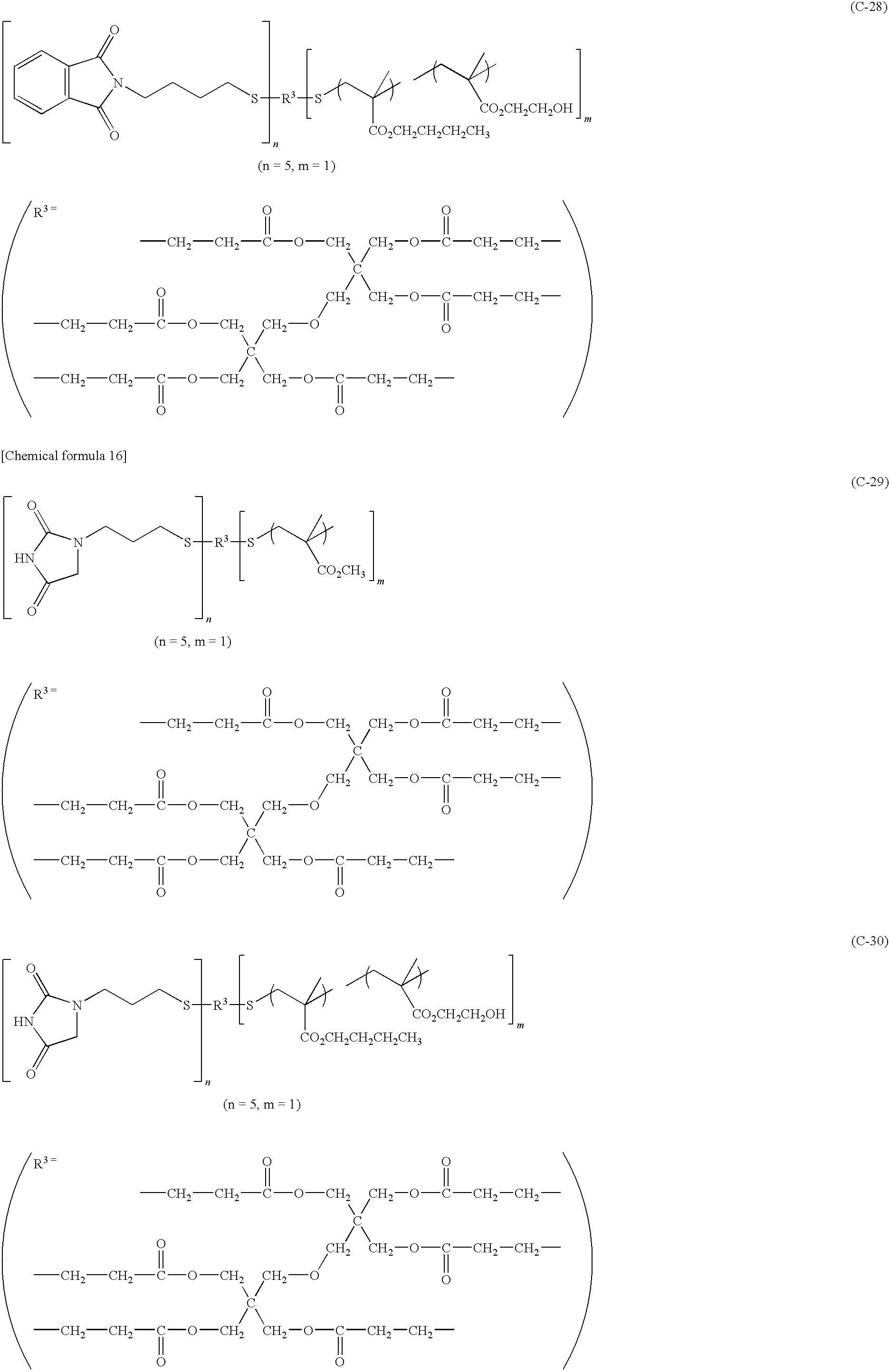

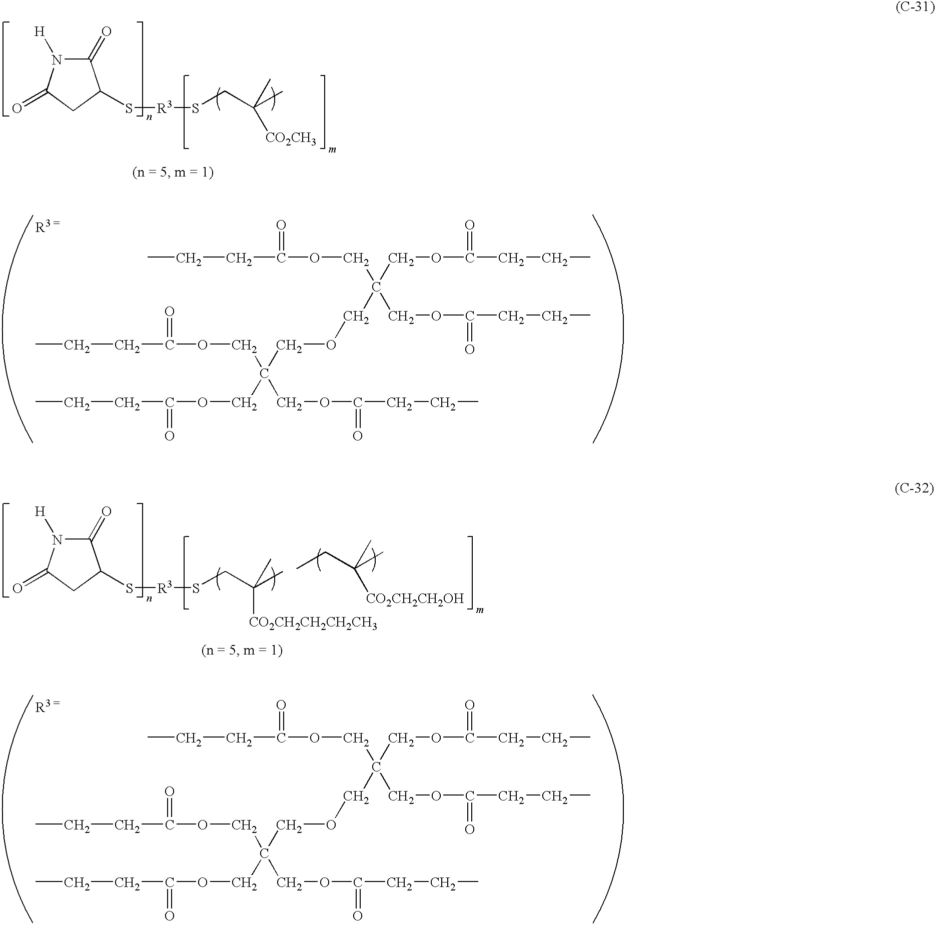

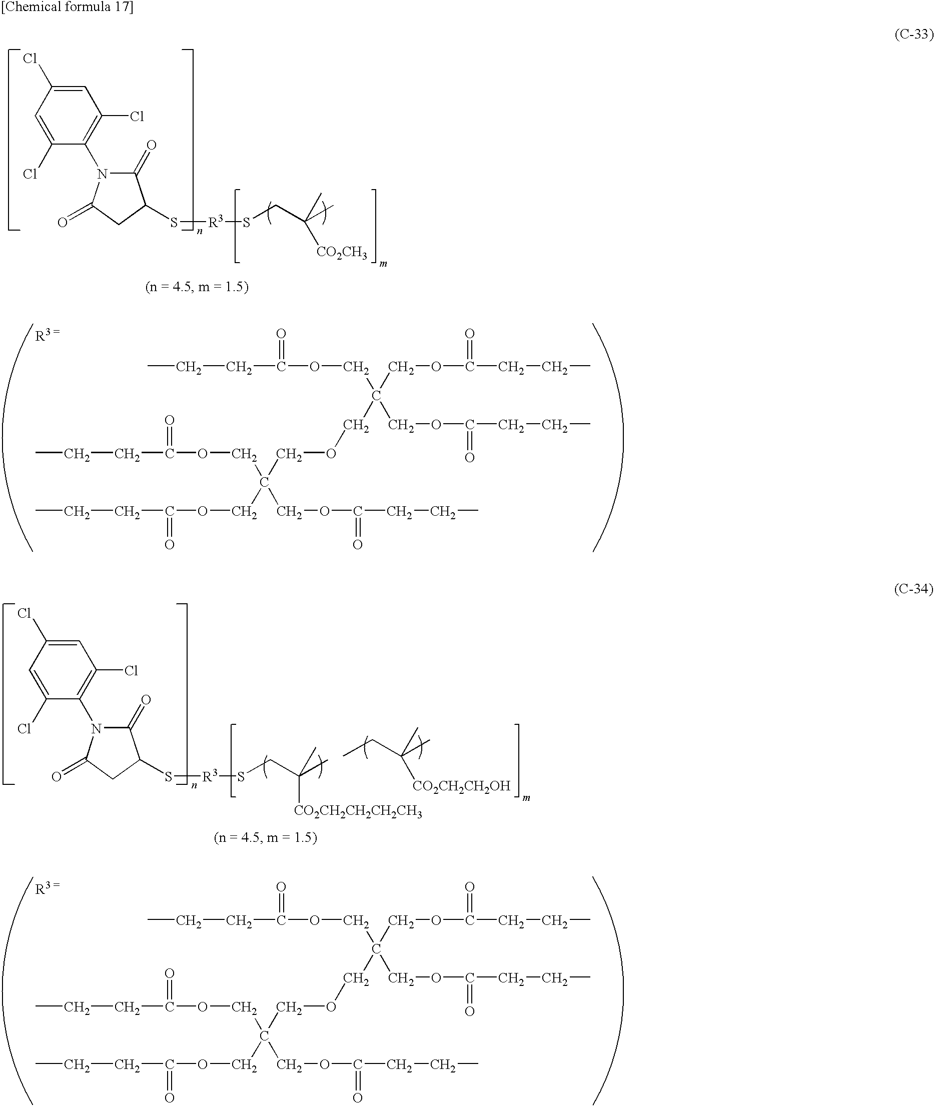

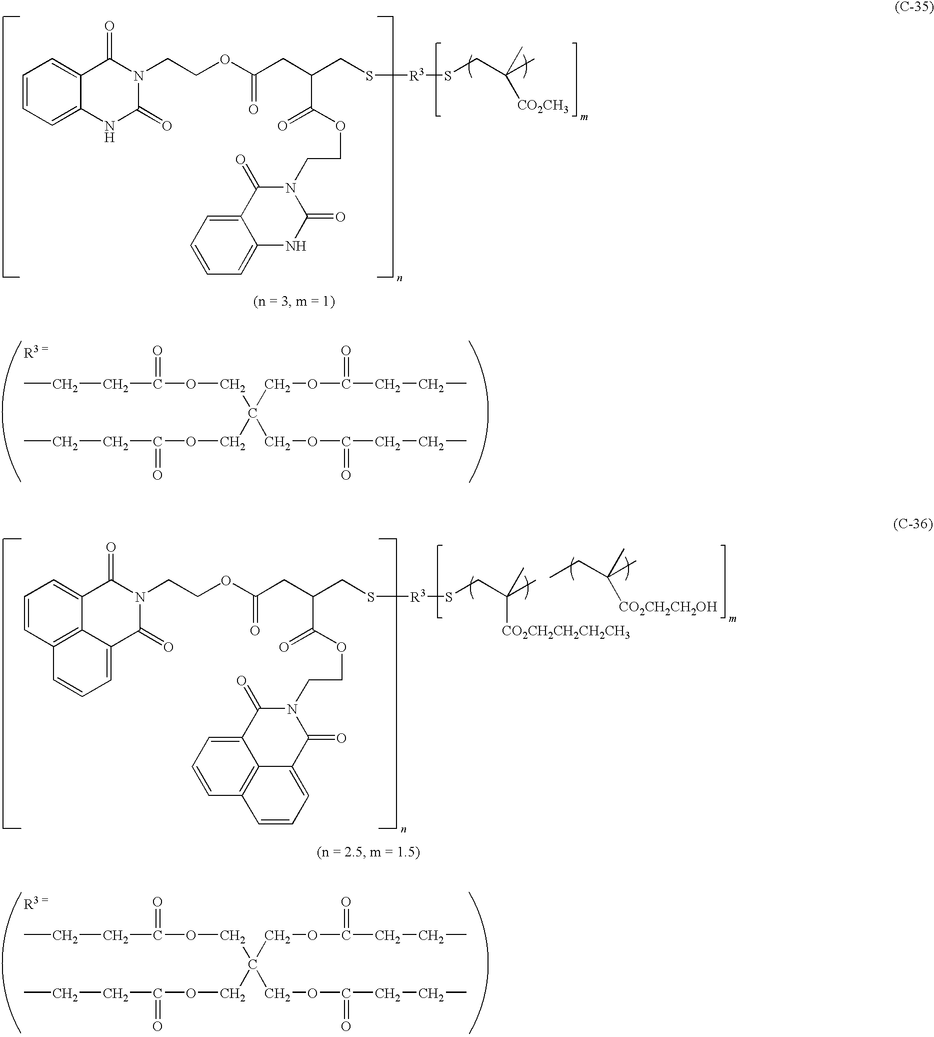

The polymer compounds represented by formula (1) or formula (2) can be prepared, for example, by the following methods.

1. Reaction of a polymer having a terminal functional group selected from carboxyl, hydroxyl, amino and other groups with an acid halide having multiple functional groups (A¹ or A² in the formula above), an alkyl halide having multiple functional groups (A¹ or A² in the formula above), an isocyanate having multiple functional groups (A¹ or A² in the Formula above), or the like

2. Michael addition of a polymer having a terminal carbon-carbon double bond with a mercaptan having multiple functional groups (A¹ or A² in the formula above)

3. Reaction of a polymer having a terminal carbon-carbon double bond with a mercaptan having multiple functional groups (A¹ or A² in the formula above) in the presence of a radical generator

4. Reaction of a polymer having terminal multiple mercaptan groups with a functional group (A¹ or A² in the formula above) having a carbon-carbon double bond in the presence of a radical generator

5. Radical polymerization of a vinyl monomer with using a mercaptan compound having multiple functional groups (A¹ or A² in the formula above) as a chain transfer agent.

Among the synthetic methods, the synthetic methods 2, 3, 4, and 5 are more preferable, the synthetic methods 3, 4, and 5 are further preferable, and the synthetic method 5 is particularly preferable, from the viewpoint of simplicity of synthesis. Descriptions in paragraphs 0184 to 0216 of the Japanese Patent Application Publication of Japanese Patent Application No. 2006-129714 may be of reference to these synthetic methods.

As the polymer compound having a mass average molecular weight of at least 1,000, it is possible to use any of the following polymer compounds having an acidic group (hereinafter, this compound is also referred to as an “acidic-group-containing polymer compound”). As the polymer compound, preferred is a polymer compound having a carboxyl group. More preferred are copolymer compounds containing (A) at least one kind of repeating unit derived from a compound having a carboxyl group and (B) at least one kind of repeating unit derived from a compound having a carboxylic acid ester group.

The repeating unit (A) derived from a compound having a carboxyl group is preferably a repeating unit represented by formula (1), and more preferably a repeating unit derived from acrylic acid or methacrylic acid; and the repeating unit (B) derived from a compound having a carboxylic acid ester group is preferably a repeating unit represented by formula (II), more preferably a repeating unit represented by formula (IV), and particularly preferably a repeating unit derived from benzyl acrylate, benzyl methacrylate, phenethyl acrylate, phenethyl methacrylate, 3-phenylpropyl acrylate, or 3-phenylpropyl methacrylate.

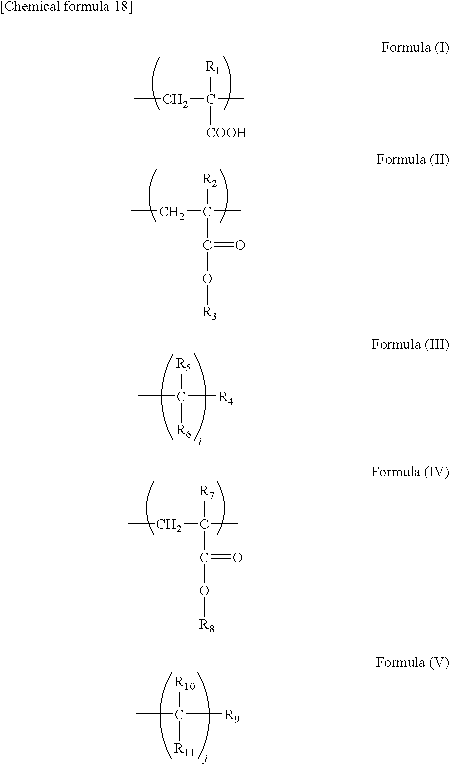

In the formulae, R₁ represents a hydrogen atom or an alkyl group having 1 to 5 carbon atoms. R₂ represents a hydrogen atom or an alkyl group having 1 to 5 carbon atoms. R₃ represents a group represented by formula (III). R₄ represents a hydrogen atom, an alkyl group having 1 to 5 carbon atoms, a hydroxy group, a hydroxyalkyl group having 1 to 5 carbon atoms, or an aryl group having 6 to 20 carbon atoms. R₅ and R₆ each represent a hydrogen atom or an alkyl group having 1 to 5 carbon atoms. i represents a number of 1 to 5. R₇ represents a hydrogen atom or an alkyl group having 1 to 5 carbon atoms. R₈ represents a group represented by formula (V). R₉ represents an alkyl group having 2 to 5 carbon atoms or an aryl group having 6 to 20 carbon atoms. R₁₀ and R₁₁ each represent a hydrogen atom or an alkyl group having 1 to 5 carbon atoms. j represents a number of 1 to 5.

As to a polymerization ratio between the repeating unit (A) derived from a compound having a carboxyl group and the repeating unit (B) derived from a compound having a carboxylic acid ester group, a ratio (%) of the number of repeating units (A) to the total number of repeating units is preferably 3 to 40, and more preferably 5 to 35.

Examples of the polymer compound having a carboxyl group include polyacrylic acid, polymethacrylic acid, and a cellulose derivative having a carboxyl group in any one of its side chains. Examples of such a polymer compound include a methacrylic acid copolymer, an acrylic acid copolymer, an itaconic acid copolymer, a crotonic acid copolymer, a maleic acid copolymer, and a partially-esterified maleic acid copolymer, as described in JP-A-59-44615, JP-B-54-34327, JP-B-58-12577, JP-B-54-25957, JP-A-59-53836, and JP-A-59-71048. In addition, particularly preferable examples of the copolymer include an acrylic acid/acrylate copolymer, a methacrylic acid/acrylate copolymer, an acrylic acid/methacrylate copolymer, a methacrylic acid/methacrylate copolymer, and a multiple-component copolymer containing acrylic acid or methacrylic acid, and an acrylate or methacrylate, and any other vinyl compound, as described in U.S. Pat. No. 4,139,391.

Examples of the vinyl compound include styrene or a substituted styrene (such as vinyltoluene or vinyl ethyl benzene); vinylnaphthalene or a substituted vinylnaphthalene; acrylamide; methacrylamide; acrylonitrile; and methacrylonitrile. Of those, styrene is preferable.

Examples of the polymer compound having a mass average molecular weight of 1,000 or more include, other than the aforementioned compounds, polyvinyl pyrrolidone, polyvinyl alcohol, polyvinyl methyl ether, polyethylene oxide, polyethylene glycol, polypropylene glycol, polyacrylamide, vinyl alcohol/vinyl acetate copolymer, partial-formal products of polyvinyl alcohol, partial-butyral products of polyvinyl alcohol, vinylpyrrolidone/vinyl acetate copolymer, polyethylene oxide/propylene oxide block copolymer, polyamides, cellulose derivatives, and starch derivatives. Besides, natural polymer compounds can also be used, examples of which include alginic acid salts, gelatin, albumin, casein, gum arabic, tragacanth gum, and ligninsulfonic acid salts. Examples of the polymer compound having an acidic group include polyvinyl sulfuric acid and concentrated naphthalenesulfonic acid.

Examples of such a compound include phthalocyanine derivatives (EFKA-6745, a commercial product, manufactured by EFKA ADDITIVES), SOLSPERSE 5000 (manufactured by ZENECA); organosiloxane polymer KP341 (manufactured by Shin-Etsu Chemical Co., Ltd.), (meth)acrylic acid (co)polymers POLYFLOW No. 75, No. 90 and No. 95 (manufactured by Kyoeisha Yushi Kagaku Kogyo Co., Ltd.), a cationic surfactant such as W001 (manufactured by Yusho Co., Ltd.); nonionic surfactants, such as polyoxyethylene lauryl ether, polyoxyethylene stearyl ether, polyoxyethylene oleyl ether, polyoxyethylene octyl phenyl ether, polyoxyethylene nonyl phenyl ether, polyoxyethylene glycol dilaurate, polyethylene glycol distearate and sorbitan fatty acid ester; anionic surfactants such as W004, W005 and W017 (manufactured by Yusho Co., Ltd.); polymeric dispersants such as EFKA-46, EFKA-47, EFKA-47EA, EFKA POLYMER 100, EFKA POLYMER 400, EFKA POLYMER 401 EFKA POLYMER 450 (all of which are manufactured by Morishita & Co., Ltd.), and Disperse Aid 6, Disperse Aid 8, Disperse Aid 15 and Disperse Aid 9100 (all of which are manufactured by San Nopco Limited); various Solsperse dispersants including Solsperse 3000, 5000, 9000, 12000, 13240, 13940, 17000, 24000, 26000 and 28000 (manufactured by ZENECA); Adeka Pluronic L31, F38, L42, L44, L61, L64, F68, L72, P95, F77, P84, F87, P94, L101, P103, F108, L121 and P-123 (manufactured by ADEKA CORPORATION), and Isonet S-20 (manufactured by Sanyo Chemical Industries, Ltd.). In addition, the pigment dispersants disclosed in JP-A-2000-239554, the compound (C) disclosed in JP-B-5-72943, the compound of Synthesis Example 1 described in JP-A-2001-31885, and the like can be preferably used, too.

The polymer compound having a molecular weight of 1,000 or more may be used singly or in combination of two or more thereof, or may be used in combination with a compound having a molecular weight of less than 1,000.

Next, a preferable embodiment in which the mixed liquid is concentrated by removing a solvent component from the mixed liquid is explained.

The embodiment of concentration is not particularly limited. Liquid-solid separation methods including, for example, batch-wise or continuous filtration, centrifugation, squeezed dehydration, evaporative drying, solvent-extraction, precipitation separation, and the like are especially preferable from view point that the mixed liquid can be concentrated up to a desired concentration, and also pigment particles are prevented from change of properties. It is not necessary to complete a concentrating operation at once. Concentration may be conducted in a stepwise fashion by repeating the same technique more than once, or by a combination of multiple techniques. Alternatively, dispersions having an objective pigment concentration may be obtained in such a manner that once concentrated pigment dispersion (first concentration) is diluted again and then re-concentrated (second concentration) similar to the above-described solvent substitution.

As the filtration, a suction filtration using an ordinary filter paper as well as pressure filtration, vacuum filtration, cross-flow filtration and the like may be used. As the filter that is used for filtration, it is also possible to use various kinds of filter elements such as disc type filters and cartridge type filters that are made of materials such as a paper, a cloth, a polymer, a nonwoven cloth, a ceramic, a metal, and the like in accordance with an intended use. Among these techniques, pressure filtration using an ultrafiltration membrane, or a microfiltration membrane, or cross-flow filtration using a membrane filter is preferable because smaller particles can be filtrated by these techniques at a high speed.

As the method for ultrafiltration, methods used for desalting and concentrating silver halide emulsion can be used. Examples are those methods described in Research Disclosure, No. 10208 (1972), No. 13 122 (1975), No. 16 351 (1977) etc. While pressure difference and flow rate, which are important as the operational conditions, can be selected by referring to the characteristic curves mentioned in Haruhiko Oya, “Maku Riyo Gijutsu Handbook (Membrane Utilization Technique Handbook)”, published by Saiwai Shobo (1978), p. 275, it is preferably to find out optimum conditions for treating a organic nano-sized particle dispersion composition of interest in order to suppress aggregation of particles. As a method for supplementing the solvent lost due to passage through the membrane, there are the constant volume method where the solvent is continuously supplemented and the batch method where the solvent is intermittently added. The constant volume method is preferred in the present invention because of its relatively shorter desalting treatment time. As the solvent to be supplemented as described above, pure water obtained by ion exchange or distillation is generally used. A dispersing agent or a poor solvent for dispersing agent may be mixed in the pure water. Alternatively, the dispersing agent or the poor solvent for dispersing agent can also be directly added to the nano-sized particle dispersion.

As an ultrafiltration membrane, modules of plate-type, spiral-type, cylinder-type, hollow yarn-type, hollow fiber-type and so forth, in which a membrane is already incorporated, are commercially available from Asahi Chemical Industry Co., Ltd., Daicel Chemical Industries, Ltd., Toray Industries, Inc., NITTO DENKO CORP. and so forth. In view of the total membrane area and washability, those of hollow yarn-type and spiral-type are preferred. The fractional molecular weight, which is an index of a threshold for substances that can permeate a membrane, must be determined based on the molecular weight of the used dispersing agent. In the present invention, those having a fractional molecular weight of 5,000 to 50,000, more preferably 5,000 to 15,000, are preferably used.

As the centrifugal separation, centrifugal deposition separation using an ordinary centrifuge, as well as centrifugation filtration using a perforated wall, centrifugation filtration using a filter, centrifugation dehydration using an imperforated wall, or a skimming may be used. Among these techniques, centrifugation filtration using a filter is preferable because smaller particles can be filtrated by this technique.

A centrifugal separator may be any device. Examples of the centrifugal separator include a widely used device (e.g., a H130A-type centrifugal separator, manufactured by KOKUSAN Co. Ltd.), a system having a skimming function (function with which a supernatant layer is sucked during the rotation of the system, to discharge to the outside of the system), and a continuous centrifugal separator for continuously discharging solid matter.

As the conditions for centrifugal separation, the centrifugal force (a value representing a ratio of an applied centrifugal acceleration to the gravitational acceleration) is preferably 50 to 10,000, more preferably 100 to 8,000, and particularly preferably 150 to 6,000. The temperature at the time of centrifugal separation is preferably −10 to 80° C., more preferably −5 to 70° C., and particularly preferably 0 to 60° C., though a preferable temperature varies depending on the kind of the solvent of the dispersion liquid.

As the squeezed dehydration, it is possible to use a squeezer (KM 73 Dehydrator manufactured by Kurita Machinery Mfg. Co., Ltd.) by which a filter cloth is filled with dispersion and squeezed, or a dehydration method using a filter presser. Further, it is also possible to use a method of directly squeezing dispersion in a filter room, unless the method deteriorates a property of the produced pigment dispersion.

The squeezing conditions are not particularly limited. However, from the viewpoints of prohibiting the pigment from excessive drying, the operation temperature is preferably in the range of 0° C. to 80° C., and especially preferably from 10° C. to 30° C. The squeezing pressure is not particularly limited, as long as the pressure is suitable for apparatus used.

As the drying, it is possible to use freeze dry, drying under reduced pressure, drying by heating, or a combination thereof.

A method for freeze-drying is not particularly limited, and any method may be adopted as long as a person skilled in the art can utilize the method. Examples of the freeze-drying method include a coolant direct expansion method, a multiple freezing method, a heating medium circulation method, a triple heat exchange method, and an indirect heating freezing method. Of these, the coolant direct-expansion method or the indirect heating freezing method is preferably employed, and the indirect heating freezing method is more preferably employed. In each method, preliminary freezing is preferably performed before freeze-drying is performed. Conditions for the preliminary freezing are not particularly limited, but a sample to be subjected to freeze-drying must be uniformly frozen.

Examples of a device for the indirect heating freezing method include a small freeze-drying machine, an FTS freeze-drying machine, an LYOVAC freeze-drying machine, an experimental freeze-drying machine, a research freeze-drying machine, a triple heat exchange vacuum freeze-drying machine, a monocooling-type freeze-drying machine, and an HULL freeze-drying machine. Of these, the small freeze-drying machine, the experimental freeze-drying machine, the research freeze-drying machine, or the monocooling-type freeze-drying machine is preferably used, and the small freeze-drying machine or the monocooling-type freeze-drying machine is more preferably used.

The temperature for freeze-drying, which is not particularly limited, is, for example, about −190 to −4° C., preferably about −120 to −20° C., and more preferably about −80 to −60° C. The pressure for freeze-drying is not particularly limited either, and can be appropriately selected by a person skilled in the art. It is recommended that freeze-drying be performed under a pressure of, for example, about 0.1 to 35 Pa, preferably about 1 to 15 Pa, and more preferably about 5 to 10 Pa. The time for freeze-drying is, for example, about 2 to 48 hours, preferably about 6 to 36 hours, or more preferably about 16 to 26 hours. It should be noted, however, that these conditions can be appropriately selected by a person skilled in the art. With regard to a method for freeze-drying, reference can be made to, for example, Pharmaceutical machinery and engineering handbook by JAPAN SOClETY OF PHARMACEUTICAL MACHINERY AND ENGINEERING, Chijinshokan Co., Ltd., p. 120-129 (September, 2000), Vacuum handbook by ULVAC, Inc., Ohmsha, Ltd., p. 328-331 (1992), or Freezing and drying workshop paper by Koji Ito et al., No. 15, p. 82 (1965).

For a device for use in the drying under reduced pressure, there is no particular limitation. Examples of the device include a widely used vacuum drier and rotary pump, a device capable of drying a liquid under heat and reduced pressure while stirring the liquid, and a device capable of continuously drying a liquid by passing the liquid through a tube the inside of which is heated and reduced in pressure.

The temperature for drying under heat and reduced pressure is preferably 30 to 230° C., more preferably 35 to 200° C., and particularly preferably 40 to 180° C. The pressure for the above-mentioned reduced pressure is preferably 100 to 100,000 Pa, more preferably 300 to 90,000 Pa, and particularly preferably 500 to 80,000 Pa.

As the apparatus for drying by heating, it is possible to use an ordinary apparatus alone or in combination. For example, as the hot-air drier, a shelf-type drier, a band drier, an agitated drier, a fluid-bed drier, a spray drier, a flash drier, or the like may be preferably used. As the heat conduction-using drier, a drum drier, a multiplex tube drier, a cylindrical drier, or a screw drier may be preferably used. Further, a freeze drier, or an infrared drier may be used depending on a solvent composition. Among these apparatuses, an agitated drier, a cylindrical drier, a screw drier or like is preferably used.

The drying conditions are not particularly limited, so long as a solvent can be evaporated and materials such as a pigment and a dispersant are not denaturized by drying. However, it is considered that drying rate is delayed in an allowable temperature range depending on the kind of solvent used. Therefore, in order to increase the drying rate at that time, it is possible to combine techniques such as reduced pressure, agitated mixing, and multistage-making depending on the kind of the drier.

The aforementioned apparatus may be used alone as a matter of course. Further, multiple apparatuses may be used in combination in order to increase efficiency.

The solvent used for solvent extraction is not particularly limited, so long as the solvent has a low compatibility with respect to the dispersion, and a proper degree of affinity with respect to the pigment particles. It is preferable that the solvent is capable of forming a definite interface after still standing. When extraction is conducted with a solvent, there is also no particular limitation with respect to the use amount and addition conditions of the solvent.

The extraction solvent that can be used in the concentration extraction is not particularly limited; and a preferable extraction solvent is one which is substantially incompatible (immiscible) with the dispersion solvent (e.g. an aqueous solvent), and which forms an interface when the solvent is left standing after the mixing. (The “substantially incompatible (immiscible) with” as used in the present specification refers to a state where compatibility between the solvents is low, and the amount of the extraction solvent to be dissolved in the dispersion solvent is preferably 50 mass % or less, and more preferably 30 mass % or less. Although the amount of the extraction solvent to be dissolved in the dispersion solvent has no particular lower limit, it is practical that the amount is 1 mass % or more in consideration of the compatibility of an ordinary solvent.) Further, the extraction solvent is preferably a solvent that causes weak aggregation to such a degree that the particles can be redispersed in the extraction solvent. In the present specification, ‘weak, redispersible aggregation’ means that flock can be redispersed without applying a high shearing force such as by milling or high-speed agitation. Such a state is preferable, because it is possible to prevent strong aggregation that may change the particle size and to swell the desired pigment particles with the extraction solvent, besides the dispersion solvent such as water can be easily removed by filter filtration. As the extraction solvents, any of ester compound solvents, alcohol compound solvents, aromatic compound solvents, and aliphatic compound solvents are preferable; ester compound solvents, aromatic compound solvents, and aliphatic compound solvents are more preferable; ester compound solvents are particularly preferable.

Examples of the ester compound solvents include 2-(1-methoxy)propyl acetate, ethyl acetate, and ethyl lactate. Examples of the alcohol compound solvents include n-butanol and isobutanol. Examples of the aromatic compound solvents include benzene, toluene and xylene. Examples of the aliphatic compound solvents include n-hexane and cyclohexane. Furthermore, the extraction solvent may be a pure solvent of one of the preferable solvents above, or alternatively it may be a mixed solvent composed of plurality of the solvents.

An amount of the extraction solvent is not particularly limited, as long as the solvent can extract the particles, but the amount of the extraction solvent is preferably smaller than an amount of the particle dispersion liquid, taking extraction for concentration into consideration. When expressed by volume ratio, the amount of the extraction solvent to be added is preferably in the range of 1 to 100, more preferably in the range of 10 to 90, and particularly preferably in the range of 20 to 80, with respect to 100 of the particle dispersion liquid. A too-large amount may results in prolongation of the time for concentration, while a too-small amount may cause insufficient extraction and residual particles in the dispersion solvent.

After addition of the extraction solvent, the resultant mixture is preferably stirred and mixed well for sufficient mutual contact with the dispersion liquid. Any usual method may be used for stirring and mixing. The temperature at the time of addition and mixing of the extraction solvent is not particularly limited, but it is preferably 1 to 100° C. and more preferably 5 to 60° C. Any apparatus may be used for addition and mixing of the extraction solvent as long as it can favorably carry out each step. For example, a separatory funnel-like apparatus may be used.

To separate a concentrated extract liquid from a dispersion solvent, filtration by using a filter is preferably carried out. As an apparatus for filter filtration, use can be made, for example, of a high-pressure filtration apparatus. Preferable examples of the filter to be used include nano-sized filter, ultrafilter, and the like. It is preferable to remove a residual dispersion solvent by filter filtration, to concentrate further the particles in the thus-concentrated extract liquid and to obtain a concentrated particle liquid.

The deposition separation technique is not particularly limited, so long as decantation and separation with a separating funnel as well as other techniques make it possible to settle out particles by gravity, and to take out only the resultant condensed portion by separation.

According to the production method of the present invention, as mentioned above, it is preferable that the organic particles in aggregation state due to concentration are re-dispersed, if necessary.

The organic pigment particles contained in a liquid of organic pigment particles condensed by the above-described extraction solvent, centrifugal separation, and drying etc. are ordinarily in the state of aggregation owing to condensation. In order to re-gain an excellent dispersion state, it is preferred to obtain the organic particles as a flock that is aggregated to a degree capable of re-dispersion.

Therefore, when a degree of dispersion achieved by an ordinary dispersion method is insufficient to microparticulation, a method of achieving a higher efficiency of miniatuarization is sometimes necessitated. Even in such situation, it is possible to redisperse effectively the organic pigment particles, for example, with the below-described forth solvent owing to incorporation of the polymer compound having a mass average molecular weight of 1000 or more.

The concentration of pigment in the pigment dispersion after concentration is preferably 1% by mass or more, more preferably 5% by mass or more, and further preferably 10% by mass or more. These preferable amounts are commonly applied to the aforementioned first concentration and second concentration. The upper limit of the concentration is not particularly limited. However, as the level of concentration increases, pigment-particles become easy to aggregate as well as it sometimes takes a long time for concentration. Therefore, from a practical standpoint, the concentration of pigment is preferably 90% by mass, or less.

In the production method of the present invention, it is preferable that after solvent substitution with the third solvent, its solvent component is removed for concentration, and the forth solvent is introduced into the resultant concentrate. The forth solvent is not particularly limited. Examples of the forth solvent include esters, ethers, and ketones. Among these solvents, methyl 3-ethoxypropionate, ethyl 3-ethoxypropionate, ethyl cellosolve acetate, ethyl lactate, butyl acetate, methyl 3-methoxypropionate, 2-heptanone, cyclohexanone, ethyl carbitol acetate, butyl carbitol acetate, propylene glycol methyl ether acetate and the like are preferable. These solvents may be used singly or in combination of two or more thereof. Further, as the forth solvent, the aforementioned high boiling point organic solvents may be used. For example, if necessary, solvents having a boiling point of 180° C. to 250° C. may be used. The content of the forth solvent is preferably in the range of 10% by mass to 95% by mass with respect to a total amount of resin composition.

When redispersion is conducted by addition of the forth solvent, namely when it is necessary to re-disperse pigment nano-sized particles having been concentrated in the precedent step, for example, ultrasonic dispersers, or mechanical shear force-using dispersers may be used.

Apparatus for ultrasonic wave irradiation is preferably an apparatus that is capable of applying an ultrasonic wave at 10 kHz or more, and examples thereof include an ultrasonic wave homogenizer, an ultrasonic wave cleaning machine, and the like. The liquid temperature during ultrasonic wave irradiation is preferably kept at 1 to 100° C., more preferably 5 to 60° C., and particularly preferably 5 to 30° C., since increase in the liquid temperature leads to thermal aggregation of nano-sized particles (see Pigment dispersion technique-surface treatment and how to use dispersing agent, and evaluation for dispersibility-, TECHNICAL INFORMATION INSTITUTE CO., LTD, 1999). The temperature can be controlled, for example, by adjusting the temperature of dispersion, by adjusting the temperature of a temperature-controlling layer for controlling of dispersion temperature, or the like.

There is no particular limitation with respect to the disperser that is used when the pigment nano-sized particles having been concentrated by applying mechanical shear force are dispersed. Examples of the dispersion machine include a kneader, a roll mill, an attritor, a super mill, a dissolver, a homomixer, and a sand mill. Further, a high pressure dispersion method and a dispersion method of using fine particle beads are also exemplified as a preferable method. As the control of solution temperature, the same system as that using ultrasonic irradiation may be used. A preferable temperature is the same as that of the system using ultrasonic irradiation.

These apparatuses may be used alone or in combination. For example, it is possible to use apparatuses in combination in such manner that preliminary dispersion is conducted with a dissolver, and then fine dispersion is conducted with a beads mill. The apparatus that is used in dispersion may be selected depending on level of difficulty with respect to dispersion of the concentrate having been produced in the proceeding step as well as particle size that is required after dispersion.

As the transparent substrate that is used to produce a color filter of the present invention, it is possible to use any glass plates, such as a soda glass plate having silicon oxide membrane on the surface thereof, a low-expansion glass, and a quartz glass plate. Further, it is also possible to use any resin films, such as polyethylene terephthalate, cellulose triacetate, polystyrene, and polycarbonate.

By subjecting the substrate to a coupling treatment in advance, adhesion of the substrate to the colored photosensitive resin composition or the photosensitive resin transfer material can be improved. The method described in JP-A-2000-39033 is preferable as the coupling treatment. The thickness of the substrate is not particularly limited, and is preferably 700 to 1,200 μm in general, and particularly preferably 500 to 1,100 μm.

The embodiment in which a colored layer is formed on a substrate is not particularly limited, so long as the embodiment is a usual production method of a color filter. For example, a color filter may be obtained by the steps of forming a light-sensitive resin layer on a substrate by coating a light-sensitive resin using a spin coater, a slit coater, a roll coater, or other apparatuses similar to these coaters, followed by exposure and development, and further repeating these steps times as many as the number of color. (Specifically, slit nozzles and slit coaters described in JPA-2004-89851, JP-A-2004-17043, JP-A-2003-170098, JP-A-2003-164787, JP-A-2003-10767, JP-A-2002-79163, and JP-A-2001-310147 are preferably used.) Further, it is also preferable to use a technique of once forming a light-sensitive resin layer on a provisional support with the colored light-sensitive resin composition, and then transferring the resin layer to a substrate by a laminator, and then exposing and developing, thereby forming a colored layer, as well as a technique of forming a colored layer on a substrate by a so-called inkjet process.

As a monomer or oligomer that is used to prepare the colored light-sensitive resin composition, it is preferable that the monomer or oligomer has two or more ethylenically unsaturated double bonds and undergoes addition-polymerization by irradiation with light. The monomer or oligomer may be a compound having at least one addition-polymerizable ethylenically unsaturated group therein and having a boiling point of 100° C. or higher at normal pressure. Examples thereof include: a monofunctional acrylate and a monofunctional methacrylate such as polyethylene glycol mono(meth)acrylate, polypropylene glycol mono(meth)acrylate, and phenoxyethyl(meth)acrylate; polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl)ether, tri(acryloyloxyethyl)isocyanurate, tri(acryloyloxyethyl)cyanurate, glycerin tri(meth)acrylate; a polyfunctional acrylate or polyfunctional methacrylate which may be obtained by adding ethylene oxide or propylene oxide to a polyfunctional alcohol such as trimethylolpropane or glycerin and converting the adduct into a (meth)acrylate.

Examples of the monomer and oligomer further include urethane acrylates as described in JP-B-48-41708, JP-B-50-6034, and JP-A-51-37193; and polyester acrylates as described in JP-A 48-64183, JP-B-49-43191, and JP-B-52-30490; polyfunctional acrylates or polyfunctional methacrylates, such as an epoxy acrylate, which are reaction products of epoxy resins and (meth)acrylic acids.

Among these, trimethylolpropane tri(meth)acrylate, pentaerythritol tetra(meth)acrylate, dipentaerythritol hexa(meth)acrylate, and dipentaerythritol penta(meth)acrylate are preferable.

Further, other than the above, “polymerizable compound B” described in JP-A-11-133600 can be mentioned as a preferable example.

These monomers or oligomers may be used alone or in combination of two or more kinds. It is preferable that the monomer or oligomer has a molecular weight of 200 to 1,000.

The color filter of the present invention may be, depending on use, either a filter only having a single hue, or a filter having four color hues different from each other, for example, black, red, blue, and green, as long as the color filter is made of the phthalocyanine compound crystal. Further, there is no limitation with respect to a pattern of the colored layer on a substrate that forms a filter. For example, the pattern may be formed by sectionalizing patterns of red, blue and green with a black matrix composed of a black layer. With respect to formation of the colored layer, it is also possible to use any other embodiment that is suitable for obtaining an objective pattern, in addition to the embodiment in which light exposure is used for patterning.

The color filter of the present invention has an advantage in high contrast ratio. There is no particular limitation with respect to the system of the liquid crystal display device equipped with the color filter. The display device may be produced with a display format such as a VA system and IPS system. Of these systems, the usage of the VA system is preferable.

According to the production method of the present invention, it is possible to control the crystal to an objective crystalline form without a particular heating, addition of unnecessary additives, or application of mechanical force, and therefore it is possible to produce, with high efficiency and high purity and if necessary in an industrial production scale, phthalocyanine pigment nano-sized particle dispersion having high dispersion stability and that can be preferably used for a color filter or the like. Further, a color filter each using an inkjet ink for color filter, a colored light-sensitive resin composition, and a light-sensitive transfer material; each of which contains the phthalocyanine pigment nano-sized particle dispersion having the objective crystalline form, a liquid crystal display device using the color filter; and a CCD device using the color filter each show a high performance.

### EXAMPLES

The present invention will be described in more detail based on the following examples, but the invention is not intended to be limited thereto.

### Reference Example 1

A cupper phthalocyanine solution was prepared by dissolving 15 g of cupper phthalocyanine powder in 100 ml of methane sulfonic acid. Separately, an α-type cupper phthalocyanine dispersion was prepared, by dispersing 25 g of α-type cupper phthalocyanine in 1 liter of propylene carbonate, using an ultrasonic cleaner, so that the average particle size would be 0.1 μm. Then, the cupper phthalocyanine solution was poured into the resultant α-type cupper phthalocyanine dispersion while vigorously stirring, and they were mixed. Thus, Dispersion sample 1 having cupper phthalocyanine crystals produced was prepared.

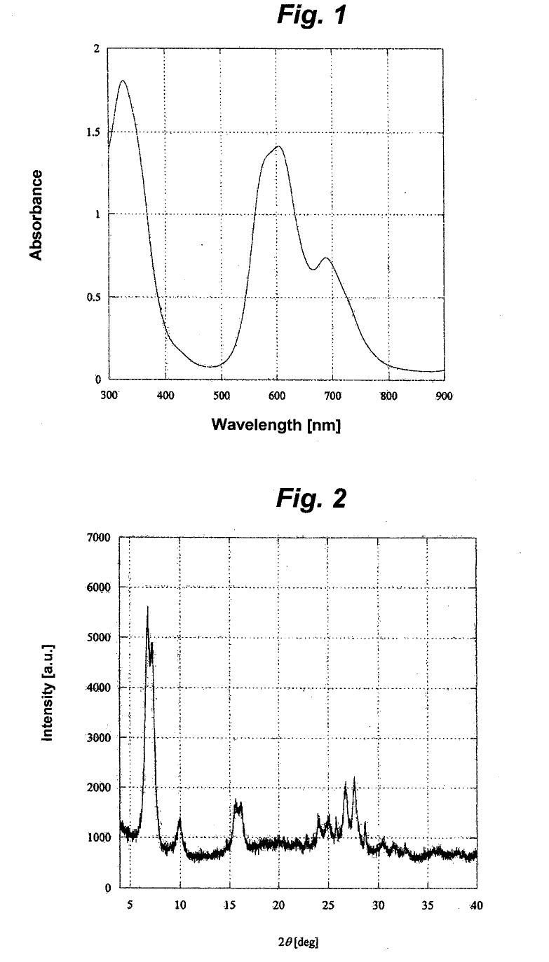

An absorption spectrum of the Dispersion sample 1 is shown in FIG. 1. After absorption measurement, the Dispersion sample 1 was filtrated with a filter to obtain 35 g of Phthalocyanine crystal sample 1 (average particle size 150 nm). The results of X-ray diffraction measurement with respect to crystal sample 1 are shown in FIG. 2. From the results, it is understood that very pure α-type cupper phthalocyanine crystals were produced.

### Reference Example 2

A cupper phthalocyanine solution was prepared by dissolving 15 g of cupper phthalocyanine powder in 100 ml of methane sulfonic acid. Separately, a β-type cupper phthalocyanine dispersion was prepared, by dispersing 25 g of β-type cupper phthalocyanine in 1 liter of propylene carbonate, using an ultrasonic cleaner, so that the average particle size would be 0.1 μm. Then, the cupper phthalocyanine solution was poured into the resultant β-type cupper phthalocyanine dispersion while vigorously stirring, and they were mixed. Thus, Dispersion sample 2 having cupper phthalocyanine crystals produced was prepared.

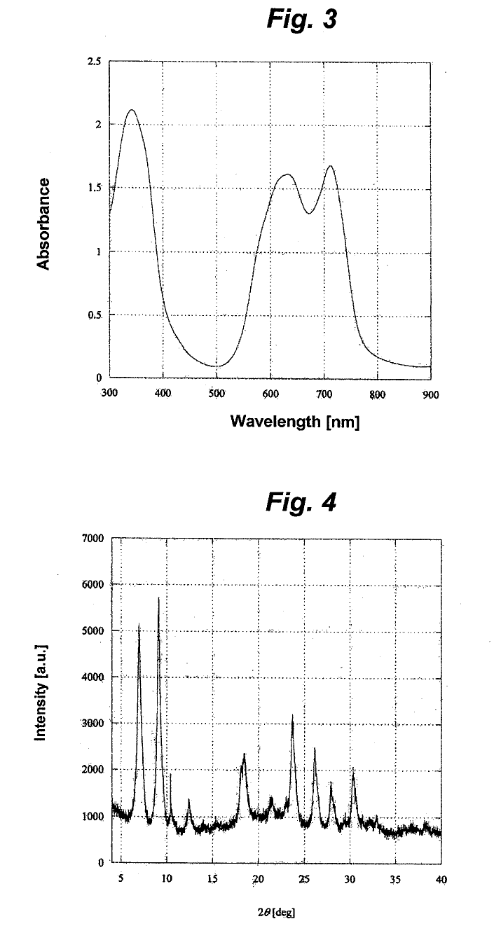

An absorption spectrum of the Dispersion sample 2 is shown in FIG. 3. After absorption measurement, the Dispersion sample 2 was filtrated with a filter to obtain 36 g of Crystal sample 2 (average particle size 200 nm). The results of X-ray diffraction measurement with respect to Crystal sample 2 are shown in FIG. 4. From the results, it is understood that very pure β-type cupper phthalocyanine crystals were produced.

### Reference Example 3

A cupper phthalocyanine solution was prepared by dissolving 15 g of cupper phthalocyanine powder in 100 ml of methane sulfonic acid. Separately, an ε-type cupper phthalocyanine dispersion was prepared, by dispersing 25 g of ε-type cupper phthalocyanine in 1 liter of propylene carbonate, using an ultrasonic cleaner, so that the average particle size would be 0.05 μm. Then, the cupper phthalocyanine solution was poured into the resultant ε-type cupper phthalocyanine dispersion while vigorously stirring, and they were mixed. Thus, Dispersion sample 3 having cupper phthalocyanine crystals produced was prepared.

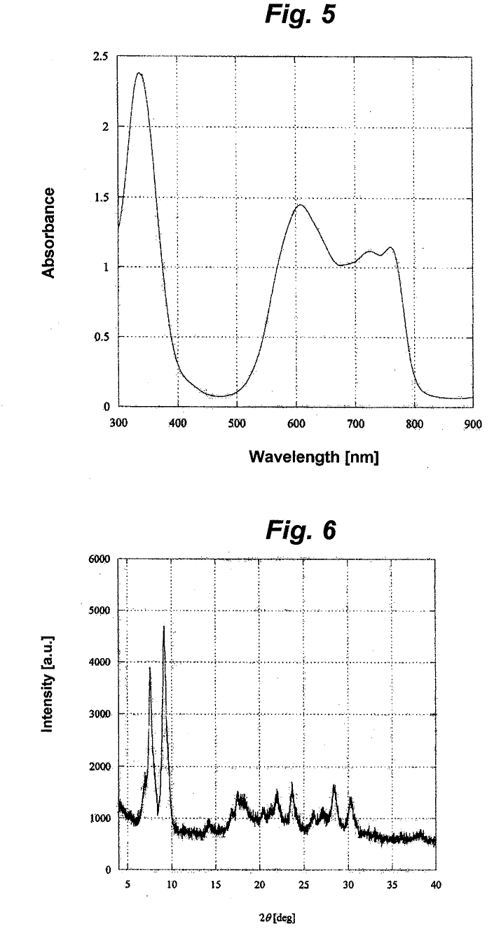

An absorption spectrum of the Dispersion sample 3 is shown in FIG. 5. After absorption measurement, the Dispersion sample 3 was filtrated with a filter to obtain 34 g of Crystal sample 3 (average particle size 100 nm). The results of X-ray diffraction measurement with respect to Crystal sample 3 are shown in FIG. 6. From the results, it is understood that very pure ε-type cupper phthalocyanine crystals were produced.

### Reference Example 4

A titanyl phthalocyanine solution was prepared by dissolving 11.5 g of titanyl phthalocyanine powder in 100 ml of methane sulfonic acid. Separately, a Y-type titanyl phthalocyanine dispersion was prepared by dispersing 1 g of Y-type titanyl phthalocyanine in 1 liter of 1-propanol, using an ultrasonic cleaner, so that the average particle size would be 0.08 μm. Then, the titanyl phthalocyanine solution was mixed with the Y-type titanyl phthalocyanine dispersion while vigorously stirring. Thus, Dispersion sample 4 having phthalocyanine crystals produced was prepared.

From the results of absorption spectrum of the Dispersion sample 4 and X-ray diffraction measurement of the Crystal sample 4 (average particle size 130 nm) obtained in the same manner as in Reference Example 1, it is understood that Y-type titanyl phthalocyanine crystals were produced.

### Reference Example 5

A titanyl phthalocyanine solution was prepared by dissolving 11.5 g of titanyl phthalocyanine powder in 100 ml of methane sulfonic acid. Separately, a β-type titanyl phthalocyanine dispersion was prepared by dispersing 1 g of β-type titanyl phthalocyanine in 1 liter of 1-propanol, using an ultrasonic cleaner, so that the average particle size would be 0.08 μm. Then, the titanyl phthalocyanine solution was mixed with the β-type titanyl phthalocyanine dispersion while vigorously stirring. Thus, Dispersion sample 5 having phthalocyanine crystals produced was prepared.

From the results of absorption spectrum of the Dispersion sample 5 and X-ray diffraction measurement of the Crystal sample 5 (average particle size 130 nm) obtained in the same manner as in Reference Example 1, it is understood that β-type titanyl phthalocyanine crystals were produced.

### Reference Example 6

A cupper phthalocyanine solution was prepared by dissolving 15 g of cupper phthalocyanine powder in 100 ml of methane sulfonic acid. Separately, ε-type cupper phthalocyanine pure water dispersion was prepared by dispersing 25 g of ε-type cupper phthalocyanine in 1 liter of pure water, using an ultrasonic cleaner, so that the average particle size would be 0.1 μm. Then, the cupper phthalocyanine solution was mixed with the resultant ε-type cupper phthalocyanine pure water dispersion while vigorously stirring. Thus, Dispersion sample R1 having phthalocyanine crystals produced was prepared.

From the results of absorption spectrum of the Dispersion sample R1 and X-ray diffraction measurement of its Crystal sample R1 (average particle size 150 nm), it is understood that a mixture of α-type cupper phthalocyanine crystals and ε-type cupper phthalocyanine crystals were produced.

### Reference Example 7

A cupper phthalocyanine solution was prepared by dissolving 15 g of cupper phthalocyanine powder in 100 ml of methane sulfonic acid. Then, the cupper phthalocyanine solution was mixed with 1,000 ml of pure water and 1,000 ml of methanol while vigorously stirring. Thus, Dispersion sample R2 containing phthalocyanine crystals was prepared.

From the results of absorption spectrum of the Dispersion sample R2 and X-ray diffraction measurement of its Crystal sample R2 (average particle size 150 nm), it is understood that α-type cupper phthalocyanine crystals were produced.

### Example 1 and Comparative Example 1

### Example 1-1

To 80 parts by mass of the dispersion sample 1, 20 parts by mass of MMPGAc (methoxypropylacetate) was added and stirred to produce a soft aggregate of crystal particles. The soft aggregate was concentrated by filtration.

To this concentrated solution, a polymer compound having an acrylic acid structure and a weight-average molecular weight of 13,000 (Exemplified compound C-1) was added to prepare a concentrated pigment liquid in paste form.

To 1.0 g of this concentrated pigment liquid in paste form, 5 ml of cyclohexanone was added to prepare a concentrated sample pigment liquid (I) for irradiation of ultrasonic waves. To the concentrated sample pigment liquid (I), 20 kHz of ultrasonic wave was irradiated for 5 minutes using a Sonifier II-type ultrasonic homogenizer manufactured by Branson Ultrasonics Corporation (ultrasonic irradiation i). Thereafter, 40 kHz of ultrasonic wave was irradiated to the same sample for 10 minutes using a Model 200 bdc-h 40:0.8-type ultrasonic homogenizer manufactured by Branson Ultrasonics Corporation (ultrasonic irradiation ii).

The ultrasonic irradiation i and the ultrasonic irradiation ii were repeated five times to such an extent that dispersion of crystal particles was visible to a naked eye. During irradiation, the sample pigment liquid was cooled so as to be maintained at 25° C. using Coolics Circulator CTW 400 manufactured by Yamato Scientific. Co., Ltd. Concentration of particles in the thus-obtained particle dispersion sample 1 was 10% by mass (concentration rate 200 times)

### Example 1-2

Particle dispersion sample 2 having the particle concentration of 10% by mass was prepared in the same manner as Example 1-1, except that the polymer compound C-1 having an acrylic acid structure was substituted with methacrylic acid/benzyl methacrylate copolymer (copolymerization molar ratio 28/72, weight average molecular weight 30,000).

### Comparative Example 1-1

Particle dispersion sample R1 having the particle concentration of 10% by mass was prepared in the same manner as Example 1-1, except that methane sulfonic acid was substituted with a polyvinyl pyrrolidone-free water, and further the polymer compound C-1 having an acrylic acid structure was substituted with methacrylic acid/benzyl methacrylate copolymer (copolymerization molar ratio 28/72, weight average molecular weight 30,000).

### Example 2 and Comparative Example 2

### Production of Photosensitive Transfer Material

A thermoplastic resin layer coating liquid having the following formulation H1 was coated on a polyethylene terephthalate film temporary support with a thickness of 75 μm using a slit nozzle, followed by drying. Then, an intermediate layer coating liquid having the following formulation P1 was coated thereon, and dried. Further, the resin composition K1 having a light-blocking property and having the formulation shown in Table 1, was coated and dried thereon. The resultant temporary support was provided with the thermoplastic resin layer having a dry film thickness of 15 μm, the intermediate layer having a dry film thickness of 1.6 μm and the light-blocking resin layer having a dry film thickness of 2.4 μm. A protective film (polypropylene film having a thickness of 12 μm) was bonded thereon under pressure additionally.

In the above described procedure, a photosensitive resin transfer material was produced in which the temporary support, the thermoplastic resin layer, the intermediate layer (oxygen blocking film) and the light-blocking resin layer were unified; and it was designated as photosensitive resin transfer material K1.

(Formulation H1 for thermoplastic resin layer coating liquid)

| | | |
|---|---|---|
| Methanol | 11.1 | mass parts |
| Propylene glycol monomethyl ether acetate | 6.4 | mass parts |
| Methyl ethyl ketone | 52.4 | mass parts |
| Methyl methacrylate-(2-ethylhexyl acrylate)- | 5.83 | mass parts |
| benzyl methacrylate-methacrylic acid copolymer | | |
| (copolymer composition ratio (mole ratio): Methyl | | |
| methacrylate/2-ethylhexyl acrylate/benzyl | | |
| methacrylate/methacrylic acid = 55/11.7/4.5/28.8, | | |
| molecular weight = 100,000, Tg: about 70° C.) | | |
| Styrene-acrylic acid copolymer (copolymerization | 3.6 | mass parts |
| composition ratio (mole ratio): Styrene/acrylic acid = | | |
| 63/37, molecular weight = 10000, Tg: 100° C.) | | |
| 2,2-bis[4-methacryloxypolyethoxy)phenyl]propane | 9.1 | mass parts |
| (manufactured by Shin-Nakamura Chemical Co., Ltd.) | | |
| Surfactant 1 | 0.54 | mass parts |

* Composition of Surfactant 1 (Megafac F-780-F
(manufactured by DIC Corporation))

| | |
|---|---|
| Copolymer of 40 mass parts of | 30 mass parts |
| C₆F₁₃CH₂CH₂OCOCH═CH₂, 55 mass parts | |
| of H(OCH(CH₃)CH₂)₇OCOCH=CH₂, and | |
| 5 mass parts of H(OCH₂CH₂)₇OCOCH═CH₂, | |
| (molecular weight: 3 × 10⁴) | |
| Methyl ethyl ketone | 70 mass part |

(Formulation P1 for intermediate layer
(oxygen blocking layer) coating liquid)

| | | |
|---|---|---|
| Polyvinyl alcohol | 32.2 | mass parts |
| (PVA205 (saponification degree = 88%); | | |
| manufactured by Kuraray Co., Ltd.) | | |
| Polyvinylpyrrolidone | 14.9 | mass parts |
| (PVP, K-30; manufactured by ISP Japan Ltd.) | | |
| Methanol | 429 | mass parts |
| Distilled water | 524 | mass parts |

TABLE 1

| | | |
|---|---|---|
| K pigment dispersion 1 (carbon black) | 25 | mass parts |
| Propylene glycol monomethyl ether acetate | 8.0 | mass parts |
| Methyl ethyl ketone | 53 | mass parts |
| Binder 1 | 9.1 | mass parts |
| Hydroquinone monomethyl ether | 0.002 | mass part |
| DPHA liquid | 4.2 | mass parts |
| Polymerization initiator 1 | 0.16 | mass part |
| Surfactant 1 | 0.044 | mass part |

### Polymerization Initiator 1

### 2,4-Bis(trichloromethyl)-6-[4′-(N,N-bisethoxycarbonylmethyl)amino-3′-bromophenyl]-s-triazine

Herein, preparation of the light-shielding resin composition K1 shown in the above Table 1 is explained below.

The light-shielding resin composition K1 was prepared as follows: First, the K pigment dispersion 1 and propylene glycol monomethyl ether acetate were weighed out in the amounts shown in Table 1, respectively, and mixed together at a temperature of 24° C. (±2° C.), and further stirred at 150 rpm for 10 minutes. Then, cyclohexanone, Binder 1, hydroquinone monomethyl ether, the DPHA liquid, 2,4-bis(trichloromethyl)-6-[4′-(N,N-bisethoxycarbonylmethyl)amino-3′-bromophenyl]-s-triazine and the surfactant 1 were weighed out in the amounts shown in Table 1, respectively, and added to the foregoing mixture in sequence in the described order at a temperature of 25° C. (±2° C.), and further stirred at 150 rpm for 30 minutes at a temperature of 40° C. (±2° C.).

In the composition shown in Table 1,
the K pigment dispersion 1 had the following composition:

| | | |
|---|---|---|
| Carbon black (manufactured by Degussa, trade name: Special Black 250) | 13.1 | mass parts |
| Pigment dispersant A | 0.65 | mass part |

| | |
|---|---|
| | [Chemical formula 19] |
| 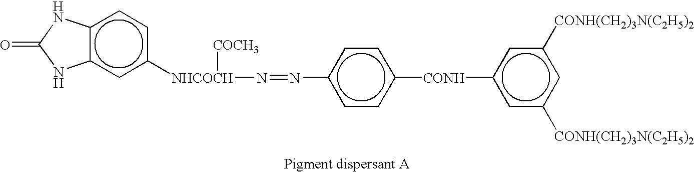 | |

| | | |
|---|---|---|
| Polymer (random copolymer of benzyl methacrylate and methacrylic acid (benzyl | 6.72 | mass parts |
| methacrylate/methacrylic acid = 72/28 by mol), molecular weight: 37,000) | | |
| Propylene glycol monomethyl ether acetate | 79.53 | mass parts |

the binder-1 had the following composition:

| | |
|---|---|
| Polymer (random copolymer of benzyl methacrylate and | 27 mass parts |
| methacrylic acid (benzyl methacrylate/methacrylic | |
| acid = 78/22 by mol), molecular weight: 40,000) | |
| Propylene glycol monomethyl ether acetate | 73 mass parts |

the DPHA liquid had the following composition:

| | |
|---|---|
| Dipentaerythritol hexaacrylate (containing | 76 mass parts |
| 500 ppm of polymerization inhibitor MEHQ; | |
| manufactured by Nippon Kayaku Co., Ltd., | |
| trade name: KAYARAD DPHA) | |
| Propylene glycol monomethyl ether acetate | 24 mass parts |

Incidentally, the surfactant 1 was identical with the surfactant 1 used in the thermoplastic resin layer coating solution H1.

### Formation of Light-Shielding Barrier Rib

A non-alkali glass substrate was washed with a rotating brush having nylon hairs while spraying a glass cleaner liquid regulated at 25° C. by a shower for 20 seconds, then the glass substrate was washed with pure water shower. Thereafter, a silane coupling solution (a 0.3 mass % aqueous solution of N-β-(aminoethyl)-γ-aminopropyltrimethoxysilane, trade name: KBM603, manufactured by Shin-Etsu Chemical Co., Ltd.) was sprayed for 20 seconds by a shower, and the substrate was washed with a pure water shower. This substrate was heat-treated by a substrate pre-heating apparatus at 100° C. for 2 minutes.

The protective film of the photosensitive resin transfer material K1 was peeled off, and the substrate heated to 100° C. for 2 minutes was laminated with the photosensitive resin transfer material K2 at a rubber roller temperature of 130° C., a linear pressure of 100 N/cm, and a conveying rate of 2.2 m/min, using a laminator (Lamic II-type, manufactured by Hitachi Industries Co., Ltd.).

After the temporary support was peeled off, the photosensitive resin was pattern-exposed by using a proximity-type exposure machine having an ultrahigh pressure mercury lamp (manufactured by Hitachi High-Tech Electronics Engineering Co., Ltd) at an exposure of 100 mJ/cm² with a distance of 200 μm between the photosensitive resin layer and the surface of the exposure mask (quartz exposure mask having image pattern), while allowing the substrate and the mask to stand straight. The mask used herein had a grid pattern, in which the radii of curvature of a salient angle on the side of the light-shielding barrier rib in the part corresponding to the boundary between each pixel and each light-shielding barrier rib was 0.6 μm.

Then, a triethanolamine-type developer (trade name: T-PD1, manufactured by Fuji Photo Film Co., Ltd., the developer contains 2.5% triethanolamine, a nonionic surfactant and a polypropylene-type antifoaming agent) was used to carry out shower-developing in the following conditions, 30° C., 50 seconds, flat nozzle pressure: 0.04 MPa, to remove the thermoplastic resin layer and intermediate layer (oxygen blocking layer).

In succession, a sodium carbonate-type developer (trade name: T-CD1, manufactured by Fuji Photo Film Co., Ltd., the developer contains 0.06 mol/1 of sodium bicarbonate, sodium carbonate having the same concentration, 1% of sodium dibutylnaphthalenesulfonate, anionic surfactant, antifoaming agent and a stabilizer) was used to carry out shower-developing in the following conditions, 29° C., 30 seconds, cone-type nozzle pressure: 0.15 MPa, to develop the resin layer having light-shielding ability and thereby to obtain a barrier rib patterning (a partition-wall pattern having light-shielding ability).

In succession, a cleaner (trade name: “T-SD1”, manufactured by Fuji Photo Film Co., Ltd., the cleaner contains a phosphate, a silicate, a nonionic surfactant, an antifoaming agent, and a stabilizer) was used to remove residues with using a rotary brush having a shower and a nylon hair, in the following conditions: 33° C., 20 seconds and cone-type nozzle pressure: 0.02 MPa, to obtain a light-shielding barrier rib. Thereafter, the substrate was post-exposed to light of a ultra-high pressure lamp from the resin layer side with respect to the substrate at a dose of 500 mJ/cm² and then heat-treated at 240° C. for 50 minutes.

### Water-Repellency-Providing Plasma Treatment

Thereafter, water-repellency-providing plasma treatment was performed in the following manner.

The light-shielding barrier rib-formed substrate was subjected to water-repellency-providing plasma treatment using a cathode-coupling parallel-plate plasma treatment apparatus under the following conditions;

Gas used: CF₄

Rate of gas flow: 80 sccm

Pressure: 40 Pa

RF power; 50 W

Treatment time: 30 sec

### Preparation of Inkjet Ink for Color Filter

An ink was prepared by the method described in Example 1 of JPA-2002-201387.

TABLE 2
Unit (parts by mass)

| Ingredient Content in Composition | R ink 1 | G ink 1 | B ink 1 |
|---|---|---|---|
| Concentrated pigment liquid R1 | 53 | | |
| Concentrated pigment liquid G1 | | 53 | |
| Concentrated pigment liquid B1 | | | 53 |
| Polymeric dispersant A | 2.0 | 2.0 | 2.0 |
| Binder A | 3.0 | 3.0 | 3.0 |
| Additive A1 | 2.0 | 2.0 | 2.0 |
| Additive A2 | 5.0 | 5.0 | 5.0 |
| Additive A3 | 2.0 | 2.0 | 2.0 |
| Additive A4 | 40 | 40 | 40 |

### <Polymeric Dispersant A>

SOLPERSE 24000 (trade name), manufactured by AVECIA

### <Binder A>

Benzyl methacrylate/methacrylic acid copolymer

### <Additive A1>

Dipentaerythritol pentaacrylate

### <Additive A2>

Tripropylene grycol diacrylate

### <Additive A3>

2-Methyl-1-[4-(methylthio)phenyl]-2-morpholinopropane)-1-one

### <Additive A4>

Diethylene glycol monobutyl ether acetate, 29.9 dyn/cm

### <Concentrated Pigment Liquid R1>

A concentrated pigment liquid R1 having the composition below was prepared as described below using a bead dispersing machine.

| | | |
|---|---|---|
| Pigment (Pigment Red 254) | 6.4 | g |
| Pigment-dispersing agent A | 0.6 | g |
| Polyvinylpyrrolidone (manufactured by Wako | 6 | g |
| Pure Chemical Industries, Ltd., K30, molecular | | |
| weight: 40,000) | | |
| Methacrylic acid/benzyl methacrylate copolymer | 15.8 | g |
| (molar ratio 28/72, mass average molecular weight 3 × 10⁴, | | |
| a 40% solution in 1-methoxy-2-propyl acetate) | | |
| Diethylene glycol monobutyl ether acetate | 45.3 | g |

Pigment-dispersing agent A, a powdered pigment (Pigment Red 254), 6 g of polyvinyl pyrrolidone, and a methacrylic acid/benzyl methacrylate copolymer were charged into a diethylene glycol monobutyl ether acetate solution followed by stirring, to prepare a mixed liquid. Then, the mixed liquid was subjected to dispersion treatment for 9 hours, by using zirconia beads 0.65 mm in diameter, and Motor Mill M-50 (made by Eiger Japan Co., Ltd.), under a condition that the circumferential velocity was set at 9 m/s.

### <Concentrated Pigment Liquid G1>

Concentrated pigment liquid G1 was prepared in the same manner as the preparation of concentrated pigment liquid R1, except that Pigment red 254 was substituted with Pigment green 36.

### <Concentrated Pigment Liquid B1>

Concentrated pigment liquid B1 was prepared in the same manner as the preparation of concentrated pigment liquid R1, except that Pigment red 254 was substituted with the particle dispersion sample 1 containing PB 15:6.

The mixing of the ingredients shown in Table 2 was carried out as follows: First, the pigment and the polymeric dispersant were charged into a part of the solvent, mixed and stirred with a three-rod roll and a beads mill, thereby preparing a pigment dispersion liquid. Separately, the other ingredients were charged into the remainder of the solvent, dissolved and dispersed with stirring, thereby preparing a binder solution. Then, the pigment dispersion liquid was added little by little to the binder solution while thoroughly stirring the resulting mixture with a dissolver. Thus, an inkjet ink for color filter was prepared.

### Pixel Formation

The R ink 1, the G ink 1 and the B ink 1 obtained above were first ejected into dents surrounded by the light-shielding barrier rib by using a piezoelectric head in the following manner, to give a color filter according to the present invention in the following way.

The head had 318 nozzles at a nozzle density of 150 nozzles per 25.4 mm in two nozzle row directions placed in parallel at a displacement of half nozzle gap, which eject 300 droplets per 25.4 mm of ink on the substrate in the nozzle placement direction.

The head and the ink were so controlled by circulation of hot water in the head that the temperature of the ink ejection region was kept at 50±0.5° C.

Ink ejection from the head was controlled by the piezoelectric drive signal sent to the head, to eject a droplet in an amount of 6 to 42 pl, and the ink was ejected in the present Example from the head onto a glass plate, while conveying the glass plate at the position 1 mm below the head. The conveying speed was adjustable in the range of 50 to 200 mm/s. The piezoelectric drive frequency may be raised up to 4.6 KHz, and the droplet quantity can be controlled by the setting.

The R, G, and B inks were ejected into the dents corresponding to the desired R, G and B colors, as the conveying speed and the drive frequency were so controlled that the coating amounts of the R, G, and B pigments would be respectively 1.1, 1.8, and 0.75 g/m².

The ejected ink is conveyed to the exposure unit, where it is irradiated by the light from a ultraviolet light-emitting diode (UV-LED). The UV-LED used was NCCU033 manufactured by Nichia Corporation. The LED emits a UV light at a wavelength of 365 nm from one chip, and the chip emits a light at an intensity of approximately 100 mW upon application of a current of approximately 500 mA. Multiple chips were placed at an interval of 7 mm, giving a total power of 0.3 W/cm² on the surface. The period from ink ejection to light exposure and the exposure period can be changed according to the medium traveling speed and the distance between the head and the LED. The ink after ejection was dried at 100° C. for 10 minutes and then subjected to exposure to light.

The light-exposure energy on the medium may be adjusted in the range of 0.01 to 15 J/cm² according to the settings of the distance and the traveling speed. The light-exposure energy was adjusted based on the traveling speed.

The exposure power and the light-exposure energy were determined by using a spectroradiometer URS-40D manufactured by Ushio Inc., and the integral values in the wavelength range of 220 nm to 400 nm were used.

The glass plate after ink ejection was baked in an oven at 230° C. for 30 minutes, for complete hardening of the light-shielding barrier rib and respective pixels.

### (Formation of ITO Electrode)

A glass substrate having a color filter formed thereon was loaded in a sputter apparatus, and 1300 Å thick ITO (indium tin oxide) was vacuum deposited at 100° C. on the whole surface of the said glass substrate. Thereafter, annealing at 240° C. for 90 minutes was performed, to crystallize the ITO. Thus, ITO transparent electrode was formed.

### (Formation of Spacer)

A spacer was formed on the thus-prepared ITO transparent electrode in the same manner as the spacer-forming method described in Example 1 of JP-A-2004-240335.

### (Formation of Protrusion for Controlling Orientation of Liquid Crystal)

Using a coating liquid for a positive-type photosensitive resin layer described below, a protrusion for controlling orientation of liquid crystal was formed on the ITO transparent electrode formed with the spacer.

Herein, exposure, development, and bake steps were carried out according to the following method.

A proximity-type exposure equipment (manufactured by Hitachi High-Tech Electronics Engineering Co., Ltd.) was set so that a certain photo mask would be located at the distance of 100 μm from the surface of the photosensitive resin layer. A proximity exposure was carried out through the said photo mask in an exposure energy of 150 mJ/cm² using an ultra-high pressure mercury lamp.

Subsequently, development was conducted by spraying a 2.38% tetramethyl ammonium hydroxide solution on to the substrate at 33° C. for 30 seconds using a shower-type developing apparatus. In this manner, unnecessary portions (exposed portions) of the photosensitive resin layer were removed by development. Thereby, on the substrate at the same side as the color filter, was formed the objective protrusion for controlling orientation of liquid crystal that was made by patterning the photosensitive resin layer into a desired shape.

After that, the substrate for a liquid crystal display device having formed thereon the protrusion for controlling orientation of the liquid crystal was baked under the conditions of 230° C. for 30 minutes. Thereby, a cured protrusion for controlling orientation of the liquid crystal was formed on the substrate for a liquid crystal display device.

<Formulation of positive-type
photosensitive-resin-layer coating liquid>

| | |
|---|---|
| Positive-type resist solution (FH-2413F | 53.3 mass parts |
| manufactured by Fuji Film Electronics | |
| Materials) | |
| Methyl ethyl ketone | 46.7 mass parts |
| Megafac F-780F (manufactured by Dainippon | 0.04 mass part |
| Ink & Chemicals Incorporation) | |

### (Production of Liquid Crystal Display Devices)

An alignment film composed of polyimide was further provided on the thus-obtained substrate for a liquid crystal display device.

Thereafter, a sealing agent made of an epoxy resin was printed at the positions corresponding to the outer frame of a diaphragm having a light-blocking property that was disposed so as to surround the periphery of the pixels of the color filter. In addition, after dropping thereon a liquid crystal for MVA-mode, the substrate and a counter substrate were stuck together. The stuck substrates were subjected to a thermal processing to cure the sealing agent. On each surface of the thus-obtained liquid crystal cell, a polarizing plate HLC2-2518 manufactured by Sanritz Corporation was stuck together. Subsequently, a backlight with a three-wavelength cold-cathode tube light source (FWL18EX-N manufactured by Toshiba Lighting & Technology Corporation) was formed, and the backlight was set at the back side of the liquid crystal cell provided with the polarizing plates. Thus, the liquid crystal display device of the present invention was produced.

Concentrated pigment liquid B2 was prepared in the same manner as in the preparation of the concentrated pigment liquid B1, except that the particle dispersion sample 1 containing PB 15:6 was substituted with the particle dispersion sample R1.

Then, B ink 2 was prepared in the same manner as the preparation of B ink 1 in Table 2, except that the concentrated pigment liquid B1 was substituted with concentrated pigment liquid B2. A color filter for comparison was prepared in the same manner as the color filter used in the liquid crystal display device of the present invention, except that the B ink 1 was substituted with the B ink 2. Thus, a liquid crystal display device installed with the color filter for comparison was prepared.

It is confirmed that the liquid crystal display device of the present invention has excellent deep blacks and blue image-forming power as compared to the liquid crystal display device for comparison.

### Example 3 and Comparative Example 3

### Preparation of Liquid Crystal Display Device of IPS Mode or PVA Mode

Liquid crystal display devices having the following modes were prepared each using the color filters of the present invention and for comparison.

Preparation of Liquid Crystal Display Device of PVA Mode

Above R pixels, G pixels, and B pixels as well as a black matrix provided on the color filter, a transparent electrode made of ITO (Indium Tin Oxide) was formed according to a spattering method. Subsequently, according to Example 1 of JP-A-2006-64921, a spacer was formed on the portion of the ITO membrane thus-formed above the black matrix and which corresponds to the black matrix.

Separately, as a counter substrate, a glass substrate was prepared. A patterning for the PVA mode was each applied on the transparent electrode of the color filter substrate and on the counter substrate. Further, polyimide alignment film was disposed thereon.

Thereafter, a sealing agent made of an ultraviolet curable resin was coated according to a dispenser process at the position corresponding to the outer flame of the black matrix disposed so as to surround the periphery of pixels of the color filter. After dropping thereon the liquid crystal for the PVA mode, the color filter substrate and the counter substrate were stuck together via the sealing agent. After irradiation of ultraviolet ray, the stuck substrates were subjected to a heat processing to cure the sealing agent. A polarizing plate HLC2-2518 manufactured by SANRITZ CORPORATION was put on each surface of the liquid crystal cell thus obtained. Subsequently, a backlight of the sidelight system was made up of FR1112H (chip-type LED manufactured by STANLEY ELECTRIC CO., LTD.) as a red (R) LED, DG1112H (chip-type LED manufactured by STANLEY ELECTRIC CO., LTD.) as a green (G) LED, and DB1112H (chip-type LED manufactured by STANLEY ELECTRIC CO., LTD.) as a blue (B) LED. Then, the backlight was set at the back side of the liquid crystal cell provided with the polarizing plate. Thus, the liquid crystal display devices were prepared.

Display properties were evaluated with respect to these display devices. As a result, it was confirmed that the liquid crystal display device of the present invention showed an excellent display properties compared to the liquid crystal display device for comparison.

Preparation of Liquid Crystal Display Device of IPS Mode

Above R pixels, G pixels, and B pixels as well as a black matrix provided on the color filter, a transparent electrode made of ITO (Indium Tin Oxide) was formed according to a spattering method. Subsequently, according to Example 1 of JP-A-2006-64921, a spacer was formed on the portion of the ITO membrane thus-formed above the black matrix and which corresponds to the black matrix.

To the above-obtained color filter substrate provided with a spacer, polyimide was coated and a rubbing processing was conducted to form an alignment film.

Further in combination with the above-obtained color filter substrate, another substrate at the driving side and a liquid crystal material were also used together to prepare a liquid crystal display device. Specifically, as the substrate at the driving side, a TFT substrate for IPS having an alignment of TFT and a comb-type pixel electrode (electric conducting layer) was prepared. The surface of the TFT substrate at the side where the pixel electrode and the like was provided thereon and the surface of the above-obtained color filter substrate at the side where colored pixel layers were formed thereon were arranged facing to each other. These substrates were fixed holding a gap with the above-formed spacer. The liquid crystal material was encapsulated into the gap to form a liquid crystal layer having a function of image display. On each surface of the liquid crystal cell thus obtained, a polarizing plate HLC2-2518 manufactured by SANRITZ CORPORATION was put. Subsequently, a cold-cathode tube backlight was prepared and was set at the back side of the liquid crystal cell provided with the polarizing plate. Thus, the liquid crystal display devices were prepared.

Display properties were evaluated with respect to these display devices. As a result, it was confirmed that the liquid crystal display device of the present invention showed an excellent display properties compared to the liquid crystal display device for comparison, though the liquid crystal display device of IPS mode was improved in display property less than that of the liquid crystal display device of PVA mode.

### Example 4 and Comparative Example 4

The CCD device was prepared as set forth below and imaging properties of the device were evaluated. Firstly, Pigment dispersions (1) . . . Green color G, (2) . . . Blue color B, and (3) . . . Red color R were prepared, respectively, according to the following formulations.

Pigment dispersion (1)

| | |
|---|---|
| C.I.P.G. 36 | 90 mass parts |
| C.I.P.G. 7 | 25 mass parts |
| C.I.P.Y. 139 | 40 mass parts |
| PLAAD ED 151 (manufactured by Kusumoto | 20 mass parts |
| Chemicals, Ltd.) | |
| Copolymer of benzyl methacrylate/methacrylic acid | 25 mass parts |
| (copolymerization molar ratio 70:30, weight- | |
| average molecular weight: 30,000) | |
| Propylene glycol monomethyl ether acetate | 625 mass parts |

Pigment dispersion (2)

| | | |
|---|---|---|
| C.I.P.B. 15:6 (Particulate dispersion sample 1) | 125 | mass parts |
| PLAAD ED 211 | 45 | mass parts |
| (manufactured by Kusumoto Chemicals, Ltd.) | | |
| Copolymer of benzyl methacrylate/methacrylic acid | 25 | mass parts |
| (copolymerization molar ratio = 70/30, | | |
| weight average molecular weight: 30,000) | | |
| Propylene glycol monomethyl ether acetate | 730 | mass parts |

Pigment dispersion (3)

| | |
|---|---|
| C.I.P.R. 254 | 80 mass parts |
| C.I.P.Y. 139 | 20 mass parts |
| PLAAD ED 472 | 45 mass parts |
| (manufactured by Kusumoto Chemicals, Ltd.) | |
| Copolymer of benzyl methacrylate/methacrylic acid | 25 mass parts |
| (copolymerization molar ratio = 70/30, | |
| weight average molecular weight: 30,000) | |
| Propylene glycol monomethyl ether acetate | 720 mass parts |

### (Preparation of Colored Resin Compositions)

The following composition was mixed uniformly in a stirrer with 200 parts by mass of each of the pigment dispersions in respective colors obtained above, to give a colored resin composition for color filter in each color.

<Composition>

| | | |
|---|---|---|
| Benzyl acrylate/methacrylic acid copolymer | 35 | mass parts |
| (copolymerization molar ratio = 70/30, | | |
| weight average molecular weight: 30,000) | | |
| Dipentaerythritol pentaacrylate | 38 | mass parts |
| Propylene glycol monomethyl ether acetate | 120 | mass parts |
| Ethyl-3-ethoxypropionate | 40 | mass parts |
| Halomethyltriazine-based initiator | 4 | mass parts |
| (Photopolymerization initiator, trade name: | | |
| TAZ107, manufactured by Midori Kagaku) | | |

### (Preparation of Color Filter and CCD Device)

The following composition was mixed by a stirrer, to give a resist solution for smoothening film.

[Composition]

| | | |
|---|---|---|
| Benzyl acrylate/methacrylic acid copolymer | 165 | mass parts |
| (copolymerization molar ratio = 70/30, | | |
| weight average molecular weight: 30,000) | | |
| Dipentaerythritol pentaacrylate | 65 | mass parts |
| Propylene glycol monomethyl ether acetate | 138 | mass parts |
| Ethyl-3-ethoxypropionate | 123 | mass parts |
| Halomethyltriazine-based initiator | 3 | mass parts |
| (Photopolymerization initiator, trade name: | | |
| TAZ107, manufactured by Midori Kagaku) | | |

The smoothening resist solution obtained was uniformly coated by spin coating on a 6-inch silicon wafer having a photodiode formed thereon. The rotating speed during spin coating was so controlled to give a film having a thickness of approximately 1.5 μm when the coated film after application is heat-treated on a hot plate at a surface temperature of 100° C. for 120 seconds.

The coated film was hardened in an oven at 220° C. for 1 hour, to give a smoothing film uniformly covering the surface of the photodiode formed on the silicon wafer.

Then, the colored resin compositions for color filter in respective colors G, R, and B described above were coated in that order, on the smoothing film each in an amount of 100 parts by mass with respect to the resist solution preparation composition for smoothing film, and then, dried (prebaked), pattern-exposed, alkali-developed, rinsed, and hardened and dried (post-baked), to form colored resin films, giving a color filter formed on the photodiode-carrying silicon wafer.

The patterning exposure was carried out through a 2-μm mask pattern by using an i-ray stepper (trade name: FPA-3000i5+, manufactured by Canon Inc.) at an intensity of 500 mJ/cm².

The alkali development was performed by paddle development, by using a 40 mass % aqueous solution of an organic alkaline developer (trade name: CD-2000, manufactured by Fujifilm Electronic Materials) at room temperature for 60 seconds, and the substrate was rinsed by spin showering with purified water for 20 seconds, and additionally washed with purified water. The water droplets remaining thereon were removed by blowing with air at high temperature, and the substrate was air-dried, giving a pattern, which was then post-baked on a hot plate at a surface temperature of 200° C. for 5 minutes. Thus, the CCD device of the present invention was produced.

The CCD device for comparison was prepared in the same manner as in the preparation of the above-mentioned CCD device, except that the particle dispersion sample 1 was substituted with the particle pigment dispersion sample R1.

The thus-obtained CCD devices were installed in a digital camera, respectively. Images that were obtained by photographing a color chart provided with a gray scale manufactured by Kodak Corporation under the conditions of the same light source, were observed on a monitor. As a result, in the CCD device that was prepared using the pigment nano-sized particles obtained by the production method of the present invention, a reproduced image having smoothness and high uniformity was obtained. Further, the CCD device according to the present invention showed excellent imaging properties. On the other hand, in the CCD device that was prepared using the pigment dispersion for comparison, impression was somewhat rough, and unevenness of color was observed.

### INDUSTRIAL APPLICABILITY

The phthalocyanine pigment nano-sized particle dispersion obtained by the production method of the present invention can be suitably applied to an inkjet ink for color filter, a colored light-sensitive resin composition, a light-sensitive transfer material, a color filter, a liquid crystal display device, a CCD device, and the like.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2007-108047 filed in Japan on Apr. 17, 2007, of which is entirely herein incorporated by reference.

1-11. (canceled)

12. A method of producing a phthalocyanine pigment nano-sized particle dispersion, comprising:
mixing a phthalocyanine compound solution of a phthalocyanine compound dissolved in an acid or a good solvent containing an acid, with an organic solvent that is a poor solvent with respect to the phthalocyanine compound, to prepare a mixed liquid in which a phthalocyanine compound crystal is formed,
wherein a phthalocyanine compound crystal having one crystalline form selected from the group consisting of α, β, γ, ε, δ, π, ρ, A, B, X, Y, and R is added to the organic poor solvent or the mixed liquid, thereby producing the thus-formed phthalocyanine compound crystal having the same crystalline form as that of the added phthalocyanine compound crystal, and wherein an additive having a mass average molecular weight of 1,000 or more is incorporated therein.

13. The method of producing a phthalocyanine pigment nano-sized particle dispersion as claimed in claim 12, wherein at least one of the additive having a mass average molecular weight of 1,000 or more is a polymer compound represented by formula (1): 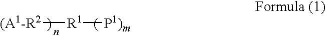
wherein R¹ represents a (m+n)-valent connecting group; R² represents a single bond or a divalent connecting group; A¹ represents a monovalent organic group having a group selected from the group consisting of an acidic group, a nitrogen-containing basic group, a urea group, a urethane group, a group having a coordinating oxygen atom, a hydrocarbon group having 4 or more carbon atoms, an alkoxy silyl group, an epoxy group, an isocyanate group, and a hydroxyl group, or a monovalent organic group containing an organic dye structure or heterocycle each of which may be substituted; when A¹s in the number of n may be the same or different from each other; m represents a number of 1 to 8; n represents a number of 2 to 9; m+n is within the range of 3 to 10; and P¹ represents a group to give a polymer compound.

14. The method of producing a phthalocyanine pigment nano-sized particle dispersion as claimed in claim 12, comprising concentrating the mixed liquid, by removing a solvent component in the mixed liquid.

15. The method of producing a phthalocyanine pigment nano-sized particle dispersion as claimed in claim 12, comprising, after the concentrating of the mixed liquid, re-dispersing the thus-produced phthalocyanine compound crystal, by adding a redispersion solvent different from each of the good solvent and the organic poor solvent.

16. A method of producing an inkjet ink for a color filter, in which the dispersion as claimed in claim 12 is obtained as an inkjet ink for a color filter.

17. A colored photosensitive resin composition, at least comprising:
the dispersion prepared by the method as claimed in claim 12;
a binder;
a polyfunctional monomer; and
a photopolymerization initiator or a photopolymerization initiator system.

18. A photosensitive transfer material, at least having a photosensitive resin layer containing the colored photosensitive resin composition as claimed in claim 17, on a temporary support.

19. A color filter, which is produced with the colored photosensitive resin composition as claimed in claim 17.

20. A color filter, which is produced with the photosensitive transfer material as claimed in claim 18.

21. A liquid crystal display device, having the color filter as claimed in claim 19.

22. The liquid crystal display device as claimed in claim 21, which is of a VA-mode.

23. A CCD device, having the color filter as claimed in claim 19.
